(19) United States
(12) Patent Application Publication
(10) Pub. No.: US 2013/0203440 A1
(43) Pub. Date: Aug. 8, 2013

(54) SELECTIVELY PERFORMING A POSITIONING PROCEDURE AT AN ACCESS TERMINAL BASED ON A BEHAVIOR MODEL

(71) Applicants: Eric P. Bilange, San Diego, CA (US); Adam W. Perry-Pelletier, San Diego, CA (US); Christopher A. Zwickilton, San Diego, CA (US); Gary G. Damm, San Diego, CA (US); Wendell Ruotsi, San Diego, CA (US); Ian R. Heidt, Carlsbad, CA (US); Lukas D. Kuhn, San Diego, CA (US)

(72) Inventors: Eric P. Bilange, San Diego, CA (US); Adam W. Perry-Pelletier, San Diego, CA (US); Christopher A. Zwickilton, San Diego, CA (US); Gary G. Damm, San Diego, CA (US); Wendell Ruotsi, San Diego, CA (US); Ian R. Heidt, Carlsbad, CA (US); Lukas D. Kuhn, San Diego, CA (US)

(73) Assignee: Qualcomm Labs, Inc., San Diego, CA (US)

(21) Appl. No.: 13/558,527

(22) Filed: Jul. 26, 2012

Related U.S. Application Data
(60) Provisional application No. 61/512,352, filed on Jul. 27, 2011.

(51) Int. Cl. H04W 4/02

(52) U.S. Cl. CPC H04W 4/021
USPC 455/456.2; 455/456.1

(57) ABSTRACT

In an embodiment, an access terminal (AT) measures and reports location information when positioned at a user-defined place associated with a geofence to a server, and the server updates a place fingerprint configured to identify the user-defined place based on the reported location information. In another embodiment, the AT or the server obtains location information associated with a set of user-defined places that are identifiable by a set of place fingerprints, determines whether a location event has occurred and updates a behavior model for the access terminal based on the determination. In another embodiment, the AT receives a request for its location and evaluates a set of factors (e.g., the behavior model, etc.) to determine whether to acquire the AT's location with a high power-consumption positioning procedure (e.g., GPS).

### CLAIM OF PRIORITY UNDER 35 U.S.C. §119

The present application for patent claims priority to Provisional Application No. 61/512,352 entitled “SELECTIVELY PERFORMING A POSITIONING PROCEDURE AT AN ACCESS TERMINAL BASED ON A BEHAVIOR MODEL”, filed Jul. 27, 2011, and assigned to the assignee hereof and hereby expressly incorporated by reference herein.

### BACKGROUND OF THE INVENTION

1. Field of the Invention

Embodiments of the present invention are directed to selectively performing a positioning procedure at an access terminal based on a behavior model.

2. Description of the Related Art

Some client applications executing on an access terminal (AT) or user equipment (UE) will, from time to time, request that a location of the AT be determined to implement location-based services. However, positioning procedures, such as Global Positioning System (GPS) based positioning procedures, consume a relatively high amount of power and thereby decrease battery life of the AT.

### SUMMARY

In an embodiment, an access terminal (AT) measures and reports location information when positioned at a user-defined place associated with a geofence to a server, and the server updates a place fingerprint configured to identify the user-defined place based on the reported location information. In another embodiment, the AT or the server obtains location information associated with a set of user-defined places that are identifiable by a set of place fingerprints, determines whether a location event has occurred and updates a behavior model for the access terminal based on the determination. In another embodiment, the AT receives a request for its location and evaluates a set of factors (e.g., the behavior model, etc.) to determine whether to acquire the AT's location with a high power-consumption positioning procedure (e.g., GPS).

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals (ATs) and access networks in accordance with at least one embodiment of the invention.

FIG. 2A illustrates a carrier network according to an embodiment of the present invention.

FIG. 2B illustrates an example of a wireless communications system in accordance with at least one embodiment of the invention.

FIG. 2C illustrates an application server in accordance with an embodiment of the invention.

FIG. 3A illustrates an access terminal (AT) in accordance with an embodiment of the invention.

FIG. 3B illustrates the AT of FIG. 3A in accordance with an embodiment of the invention.

FIG. 4A illustrates an example of a learning process by which characteristics of one or more places associated with a given AT are established in accordance with an embodiment of the invention.

FIG. 4B illustrates an example of a geofence configuration screen that can be displayed to by the given AT in association with a geofence configuration operation of FIG. 4A.

FIG. 5A illustrates a server-based behavior model generation procedure in accordance with an embodiment of the invention.

FIG. 5B illustrates an example implementation of a portion of FIG. 5A in accordance with an embodiment of the present invention.

FIG. 5C illustrates an example implementation of a portion of FIG. 5A in accordance with an embodiment of the present invention.

FIG. 5D illustrates an example behavior model in accordance with an embodiment of the present invention.

FIG. 5E illustrates a client-based behavior model generation procedure in accordance with an embodiment of the invention.

FIG. 6A illustrates a client-initiated behavior model provisioning operation in accordance with an embodiment of the invention.

FIG. 6B illustrates a server-initiated behavior model provisioning operation in accordance with an embodiment of the invention.

FIG. 7 illustrates an example of a power control procedure based on the behavior model implemented at the given AT in accordance with an embodiment of the invention.

FIG. 8A illustrates another example of a power control procedure based on the behavior model implemented at the given AT in accordance with an embodiment of the invention.

FIG. 8B illustrates an example implementation of a portion of FIG. 8A in accordance with an embodiment of the present invention.

FIG. 9 illustrates a communication device that includes logic configured to perform functionality.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

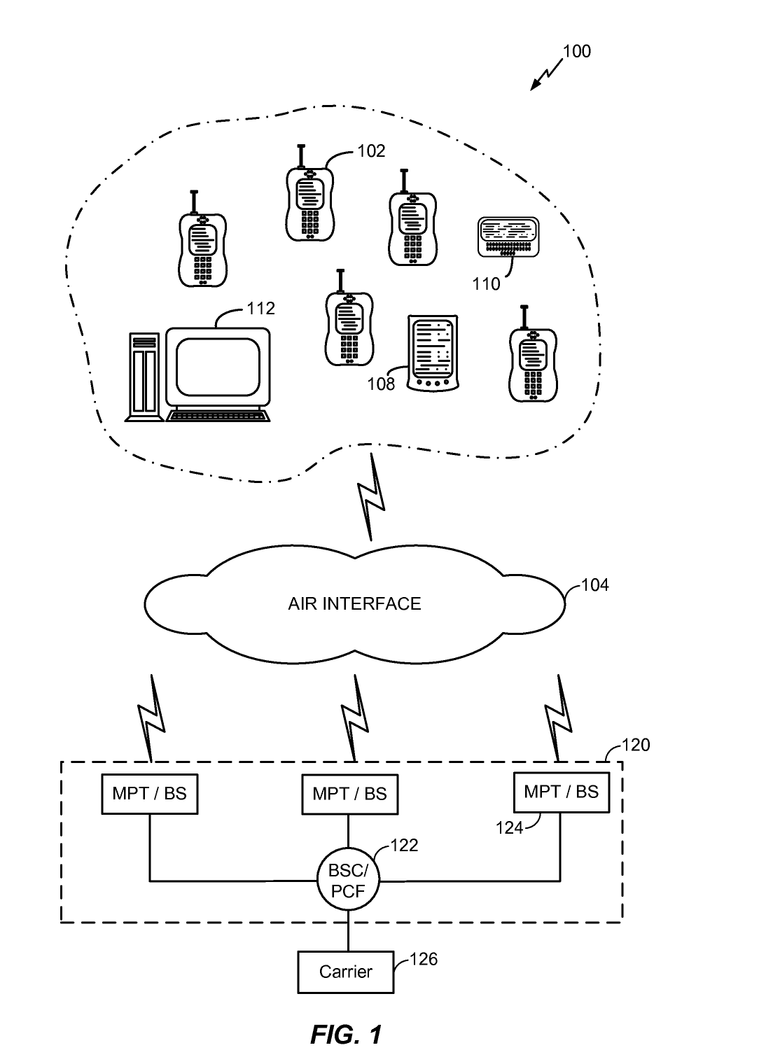

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node 160 (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the invention is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

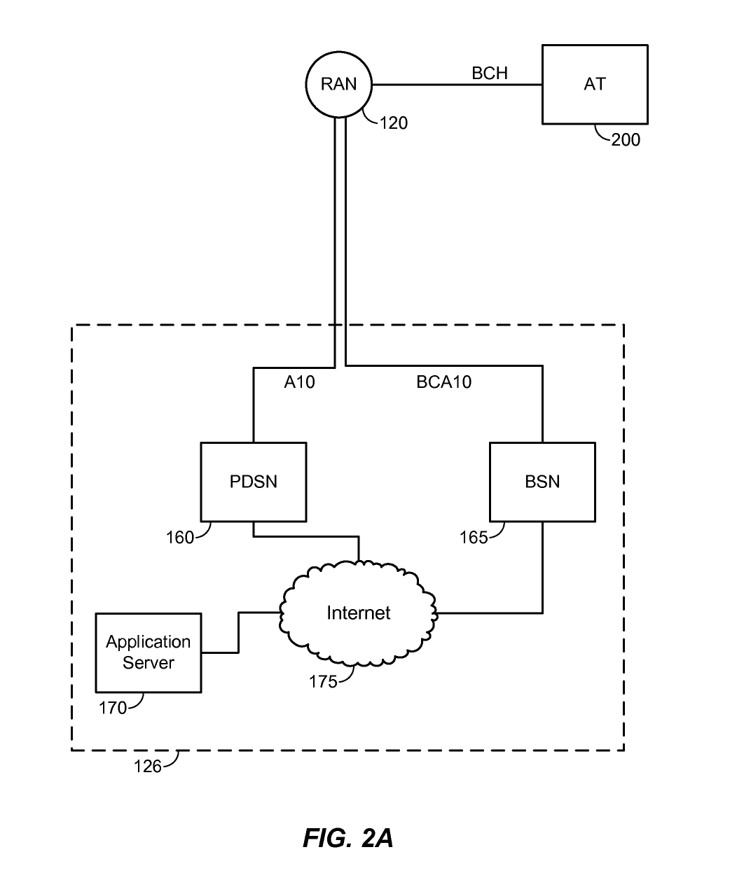

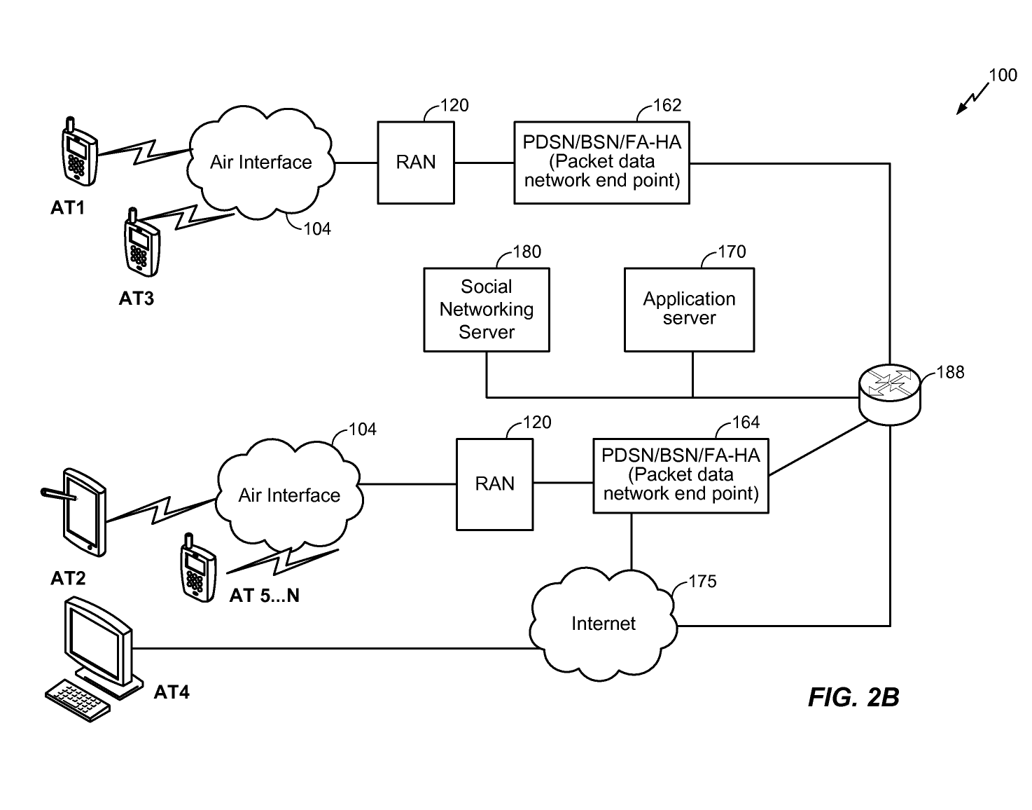

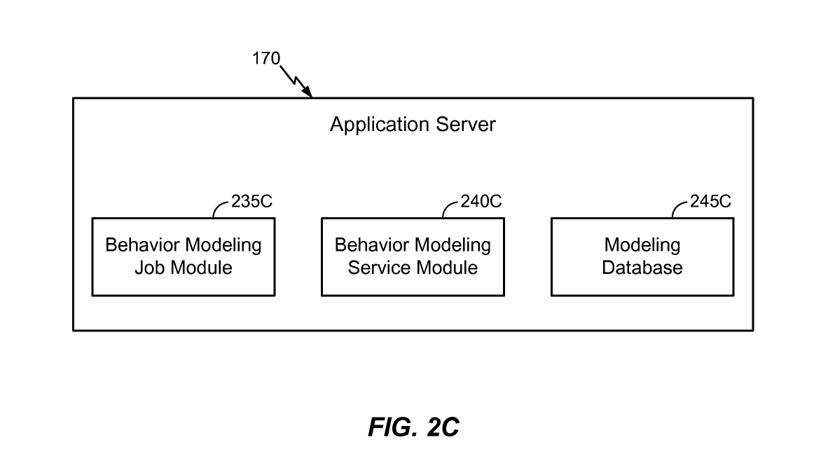

FIG. 2A illustrates the carrier network 126 according to an embodiment of the present invention. In the embodiment of FIG. 2A, the carrier network 126 includes a packet data serving node (PDSN) 160, a broadcast serving node (BSN) 165, an application server 170 and an Internet 175. However, application server 170 and other components may be located outside the carrier network in alternative embodiments. The PDSN 160 provides access to the Internet 175, intranets and/or remote servers (e.g., application server 170) for mobile stations (e.g., access terminals, such as 102, 108, 110, 112 from FIG. 1) utilizing, for example, a cdma2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2A, the PDSN 160 may communicate with the RAN 120 (e.g., the BSC/PCF 122) via a conventional A10 connection. The A10 connection is well-known in the art and will not be described further for the sake of brevity.

Referring to FIG. 2A, the broadcast serving node (BSN) 165 may be configured to support multicast and broadcast services. The BSN 165 will be described in greater detail below. The BSN 165 communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 sends unicast messaging to the PDSN 160 via the Internet 175, and sends multicast messaging to the BSN 165 via the Internet 175.

Generally, as will be described in greater detail below, the RAN 120 transmits multicast messages, received from the BSN 165 via the BCA10 connection, over a broadcast channel (BCH) of the air interface 104 to one or more access terminals 200.

FIG. 2B illustrates an example of the wireless communication 100 of FIG. 1 in more detail. In particular, referring to FIG. 2B, ATs 1 . . . N are shown as connecting to the RAN 120 at locations serviced by different packet data network end-points. Accordingly, ATs 1 and 3 connect to the RAN 120 at a portion served by a first packet data network end-point 162 (e.g., which may correspond to PDSN 160, BSN 165, a home agent (HA), a foreign agent (FA), etc.). The first packet data network end-point 162 in turn connects, via the routing unit 188, to the Internet 175 and/or to one or more of the application server 170 and one or more social networking servers 180 (e.g., a server or servers for supporting Facebook, MySpace, Twitter and/or other social networking services). ATs 2 and 5 . . . N connect to the RAN 120 at a portion served by a second packet data network end-point 164 (e.g., which may correspond to PDSN 160, BSN 165, FA, HA, etc.). Similar to the first packet data network end-point 162, the second packet data network end-point 164 in turn connects, via the routing unit 188, to the Internet 175 and/or to one or more of the application server 170 and the one or more social networking servers 180. AT 4 connects directly to the Internet 175, and through the Internet 175 can then connect to any of the system components described above.

Referring to FIG. 2B, ATs 1, 3 and 5 . . . N are illustrated as wireless cell-phones, AT 2 is illustrated as a wireless tablet-PC and AT 4 is illustrated as a wired desktop station. However, in other embodiments, it will be appreciated that the wireless communication system 100 can connect to any type of AT, and the examples illustrated in FIG. 2B are not intended to limit the types of ATs that may be implemented within the system. Also, while the application server 170 and the social networking server 180 are each illustrated as structurally separate servers, these servers may be consolidated in at least one embodiment of the invention.

FIG. 2C illustrates the application server 170 in accordance with an embodiment of the invention. Referring to FIG. 2C, the application server 170 includes a behavior modeling job module 235C, a behavior modeling service module 240C and a modeling database 245C.

Referring to FIG. 2C, the behavior modeling job module 235C is configured to generate and/or update a behavior model for a particular AT. As used herein, the behavior model corresponds to a model of the AT's movements based on a history of location information that is reported by the AT to the application server 170. As will be described in greater detail below, the behavior model can be downloaded or provisioned to the AT and then used to implement decision logic that is related to power control functions on the AT, such as when to execute a relatively high-powered positioning procedure (e.g., GPS, etc.).

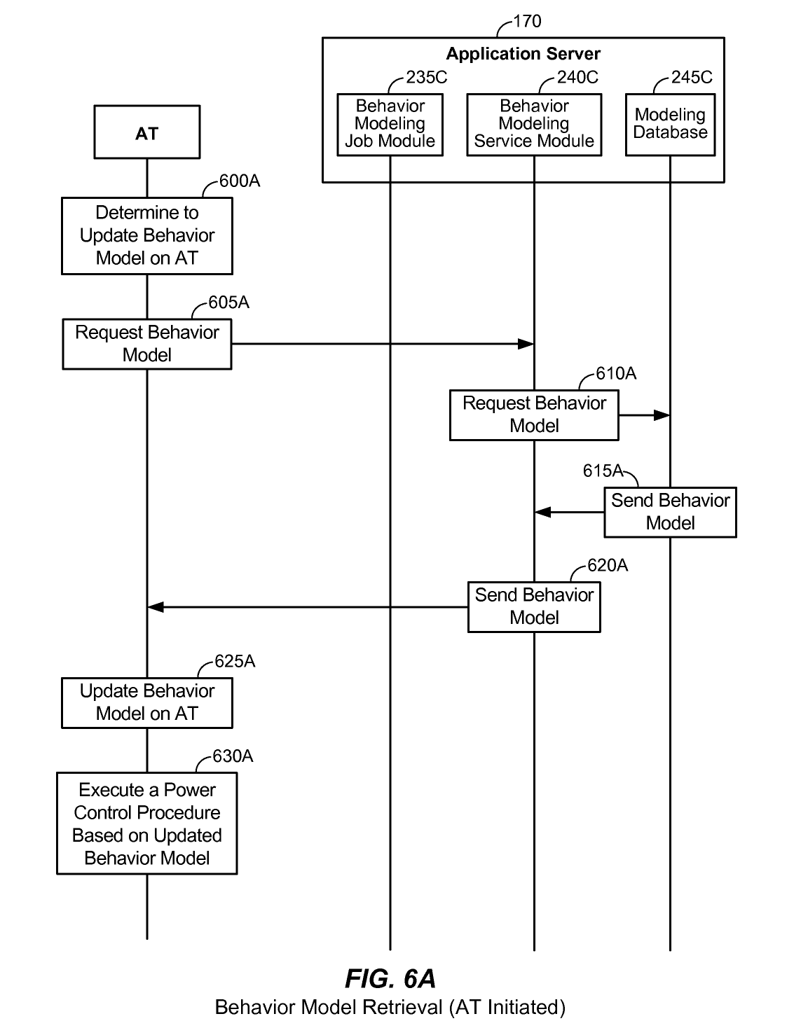

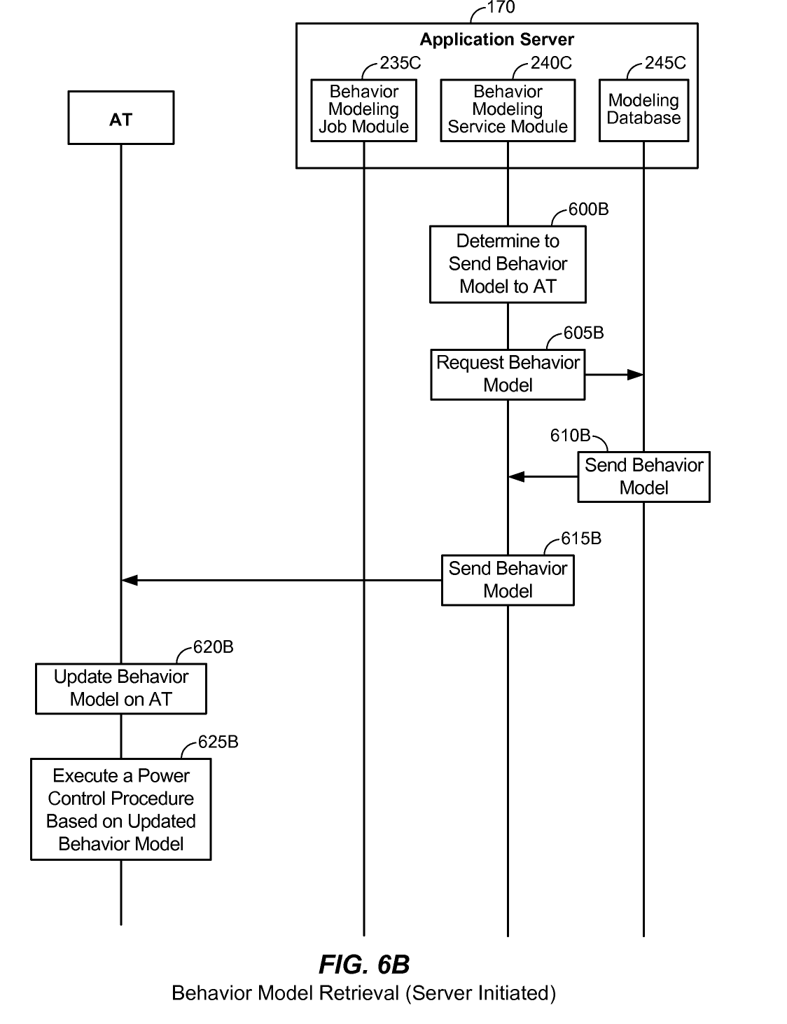

Referring to FIG. 2C, the behavior modeling service module 240C is responsible for provisioning the AT with the behavior model. This provisioning can occur either in response to a request for the behavior model that is received from the AT (e.g., as in FIG. 6A), or in an automated manner without an explicit request (e.g., in a periodic or event-driven manner) (e.g., as in FIG. 6B).

Referring to FIG. 2C, the modeling database 245C is configured to store behavior models that are generated by the behavior modeling job module 235 for one or more ATs. The modeling database 245C can provide the stored behavior models to the behavior modeling service module 240C to facilitate the provisioning of the behavior models to the respective ATs. In addition to storing the behavior models, the modeling database 245C can also be configured to store (i) at least a portion of the raw location information that is used by the behavior modeling job module 235C to generate the behavior modules, in an example, and (ii) a set of places with associated place fingerprints that are used by the behavior modeling job module 235C to generate and/or update the behavior module for a given AT.

As will be appreciated, the modules 235C through 245C of the application server 170 can interact with each other to achieve their respective functionality, as will be described in greater detail below.

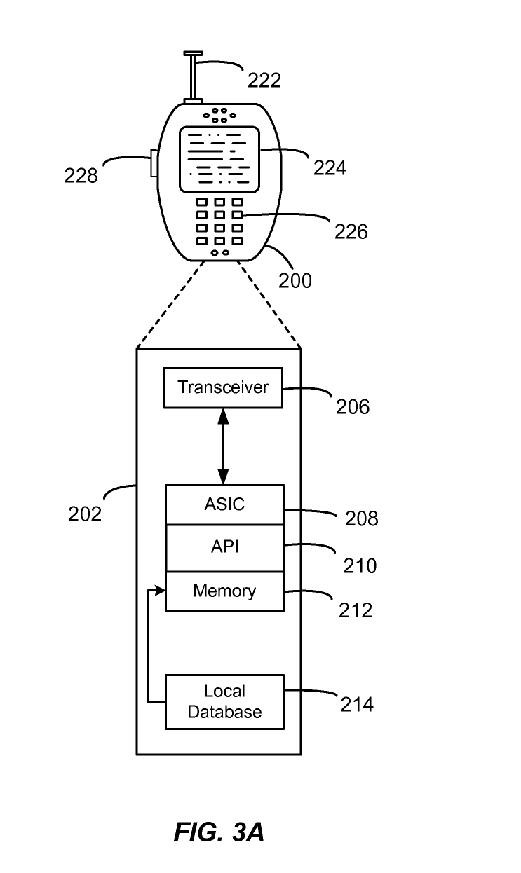

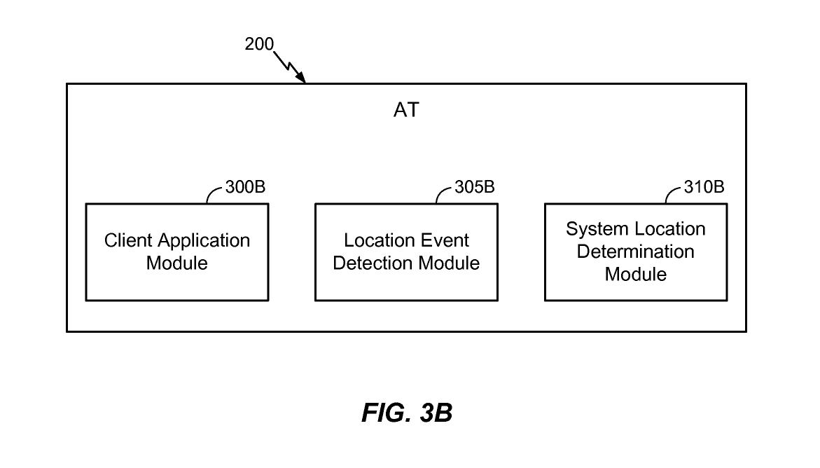

Referring to FIG. 3A, an access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3A are to be considered merely illustrative and the invention is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, MPT/BS 124, and BSC/PCF 122. The BSC/PCF 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the invention and are merely to aid in the description of aspects of embodiments of the invention.

FIG. 3B illustrates the AT 200 in accordance with an embodiment of the invention. Referring to FIG. 3B, the AT 200 includes at least one client application module 300B that is configured to perform location-based services for a user of the AT 200, a location event detection module 305B and a system location determination module 310B.

Referring to FIG. 3B, the at least one client application module 300B can correspond to any type of client application (e.g., a PTT application, a calendar application, a restaurant guide application, an E-Mail application, etc.) that is configured to, from time to time, request access to a location of the AT to implement one or more location-based services.

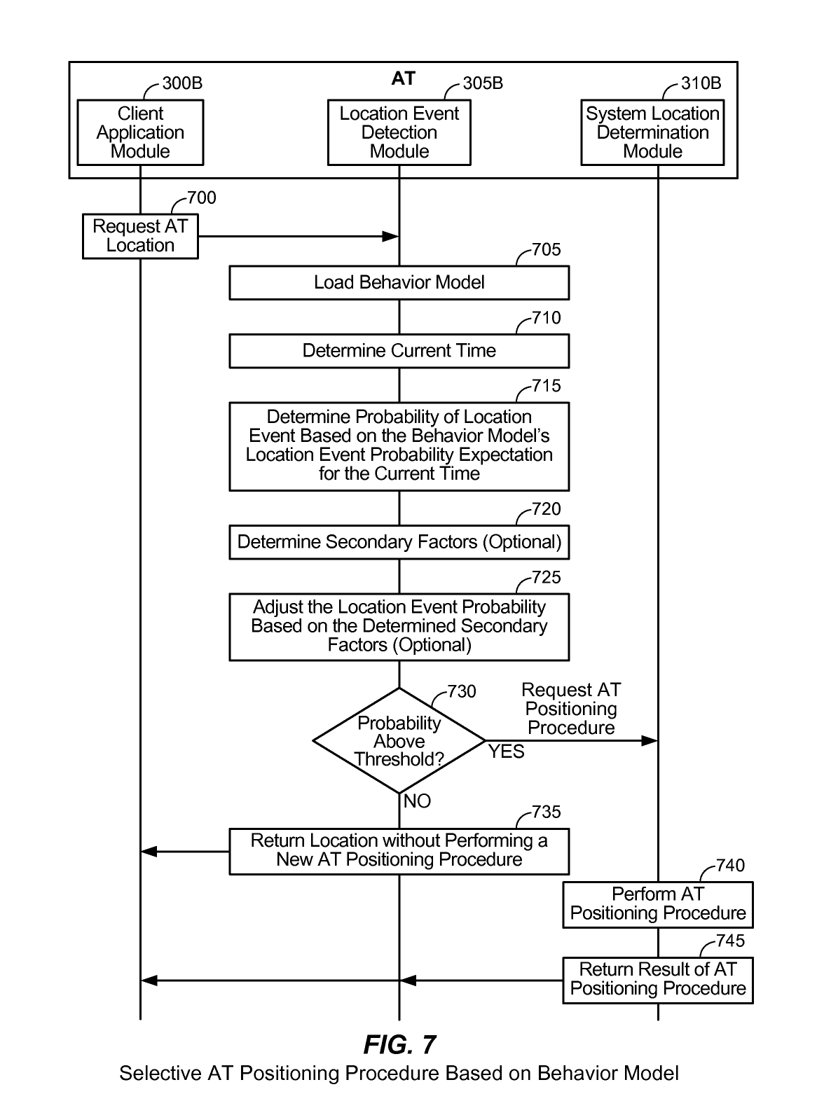

Referring to FIG. 3B, the location event detection module 305B is responsible for determining when to authorize the system location determination module 310B to execute a positioning procedure of the AT 200. As will be described in more detail below, this determination is based at least in part on the behavior model for the AT 200. Generally, the location event detection module 305B determines a probability of a “location event” based in part on the behavior profile. As will be described in greater detail below with respect to FIG. 7, the location event detection module 305B then uses this probability as a factor in the determination as to whether the launch a relatively power intensive positioning procedure (e.g., a GPS procedure) by the system location determination module 310B, or alternatively whether to conserve power by predicting the AT 200's location without invoking the system location determination module 310B (e.g., by assuming the AT 200's location corresponds to an earlier-calculated position or place, or a predicted place based on the behavior profile).

Referring to FIG. 3B, the system location determination module 310B is configured to execute one or more relatively power intensive positioning procedures by which the location of the AT 200 can be estimated. For example, the positioning procedure(s) configured for execution by the system location determination module 310B can include a GPS positioning procedure, trilateration, hybrid GPS/cellular positioning procedure, and/or any other well-known positioning procedure.

As will be appreciated by one of ordinary skill in the art, performing positioning procedures, such as GPS, at a given AT consumes a high amount of power and degrades battery life. Accordingly, embodiments of the invention are directed to selectively performing positioning procedures at the given AT based in part on a behavior model that is specific to the given AT. As will be explained in greater detail below, the behavior profile for the given AT can be used to estimate a probability that the location of the given AT can be predicted without performing the positioning procedure.

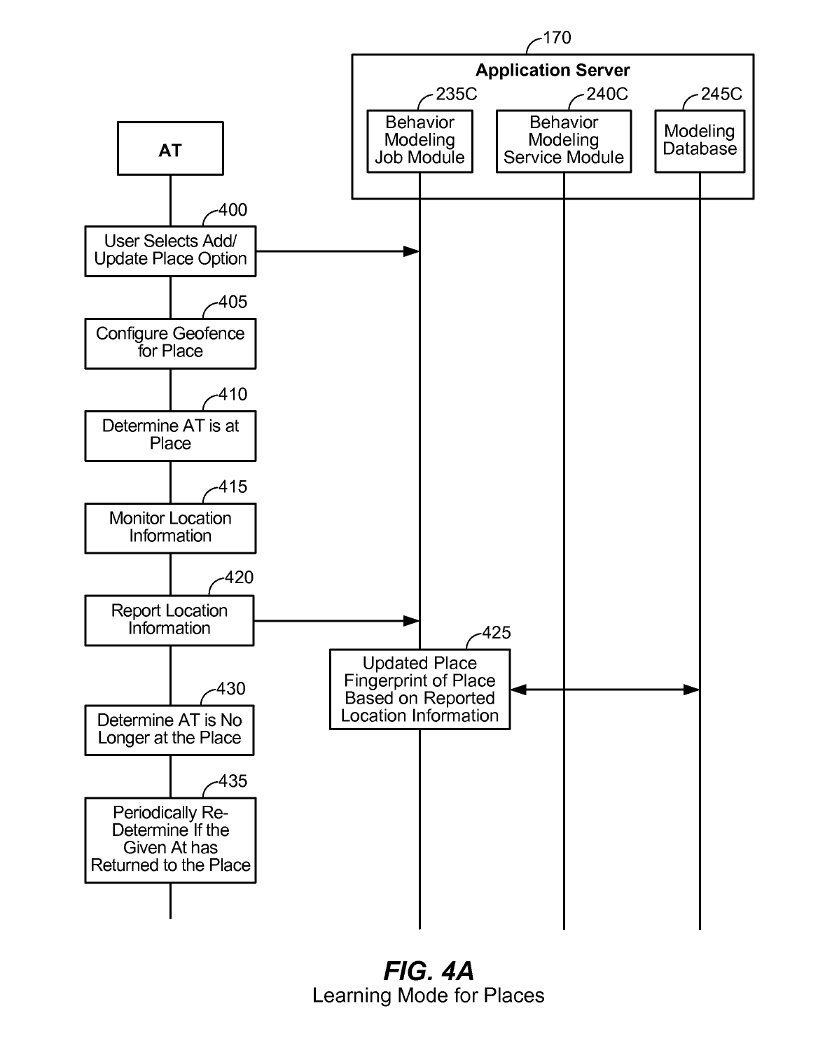

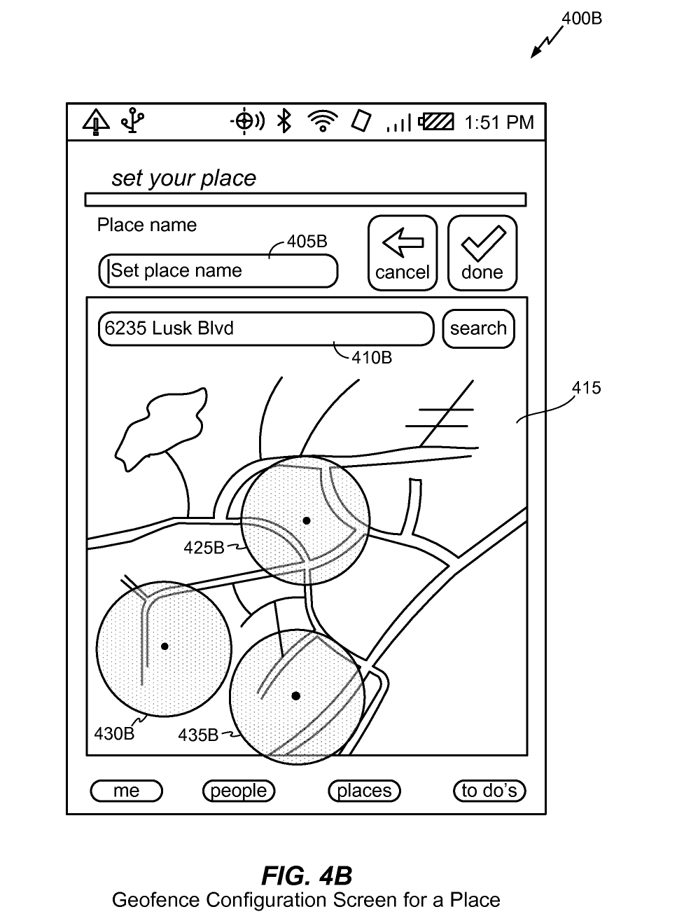

FIG. 4A illustrates an example of a learning process by which characteristics (or a place fingerprint) of one or more places associated with the given AT are established in accordance with an embodiment of the invention. Referring to FIG. 4A, assume that a user of the given AT has activated a place learning mode associated with a location-based client application on the given AT, and that the user of the given AT selects an option to add or update a place, 400. For example, the place can correspond to the user's homeplace, workplace, a library, a restaurant, and so on. After the user selects the add or update place option, the user configures a geofence to be associated with the place, 405.

FIG. 4B illustrates an example of a geofence configuration screen 400B that can be displayed to the user of the given AT in association with the geofence configuration operation of 405 of FIG. 4A. As shown in FIG. 4B, the geofence configuration screen 400B includes a field 405B where the user can input a name associated with the place (e.g., “Home”, “Work”, etc.), a location input field 410B and a map display 415B. As an example, after block 400 of FIG. 4A, the geofence configuration screen 400B may be displayed to the user. Then, in block 405, the user can configure the geofence for the place by inputting a target location (or address) into the location input field 410B (e.g., “6235 Lusk Blvd”, “Current Location”, etc.), after which the map display 415B zooms to show the target location with a proposed geofence, 425B. At this point, the user can adjust the radius of the geofence (e.g., from an initial geofence radius, such as 200 meters) and/or drag the proposed geofence 425B to a new location altogether. Once the user is satisfied that the geofence on the map display 410B represents his/her desired bounds for the place, the user names the place and selects “Done”, after which the name that place, and hit “done”. This place is now saved to their list of places locally, and is also sent to the application server 170. Also shown in the map display 415B are pre-established places associated with geofences 430B and 435B. While the geofences 425B, 430B and 435B are each illustrated as circular regions in FIG. 4B, in other embodiments the geofences can correspond to polygons and/or other shapes.

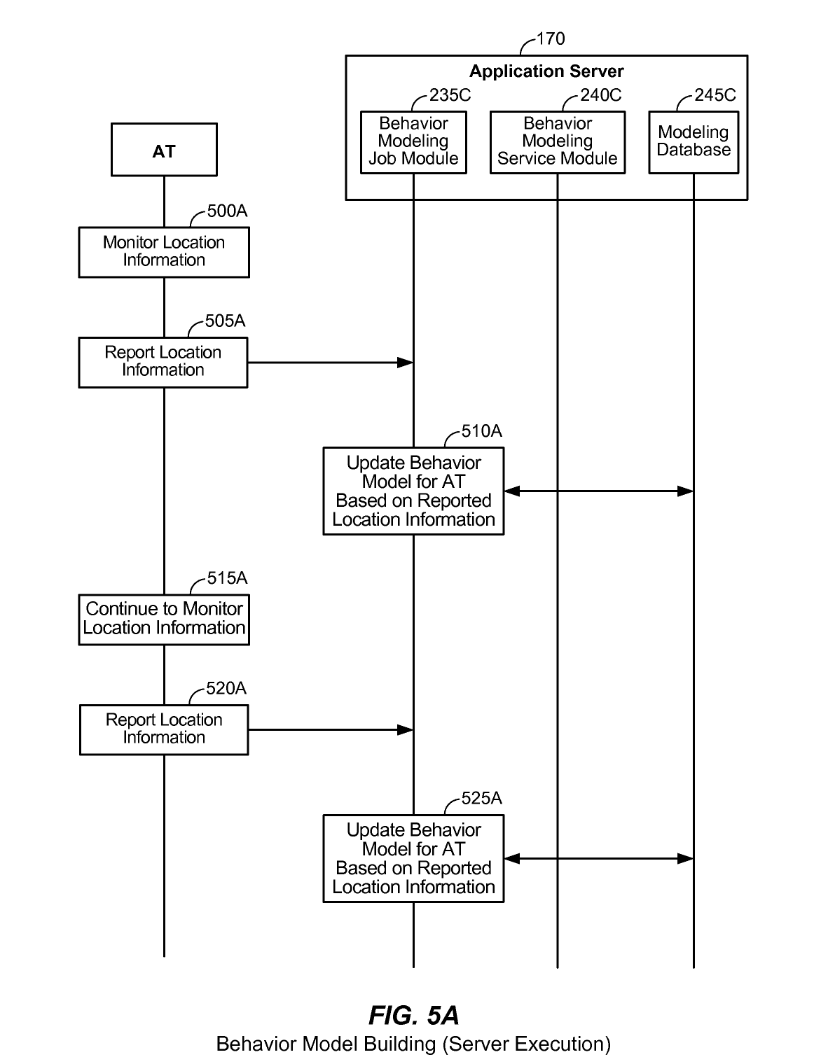

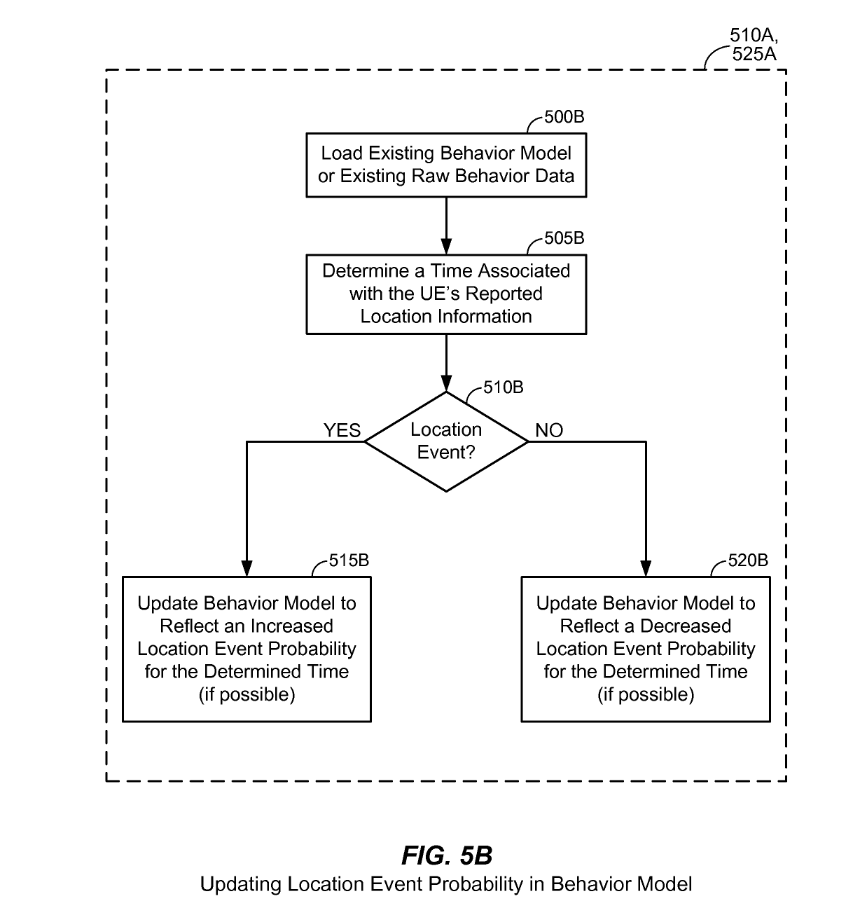

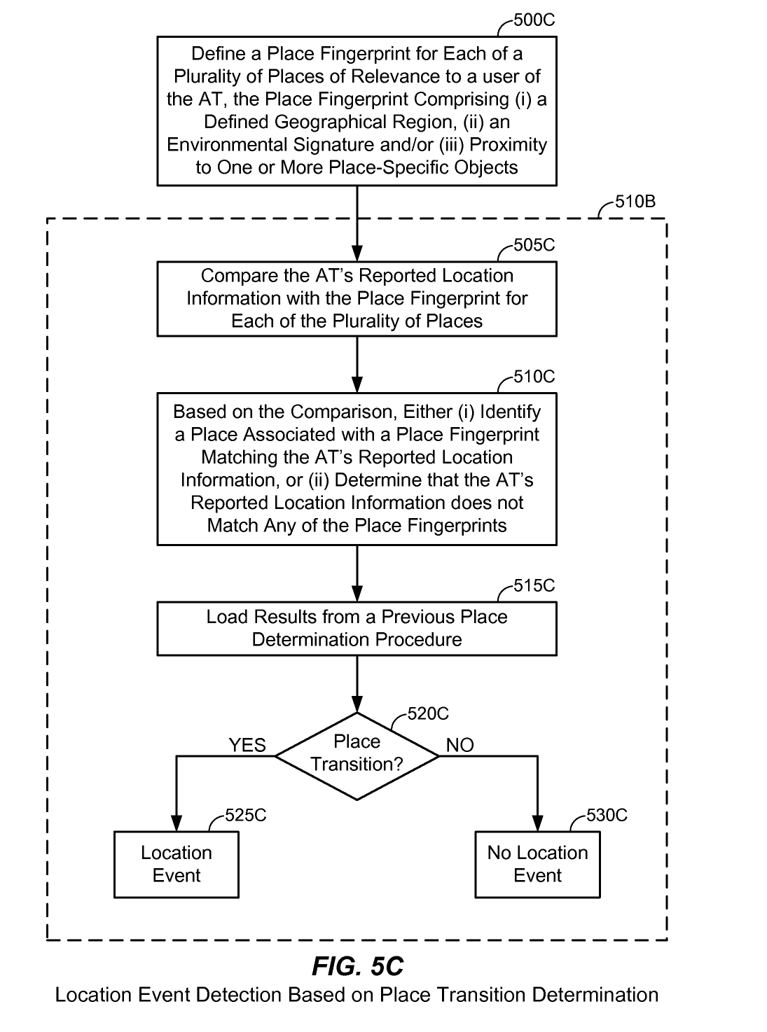

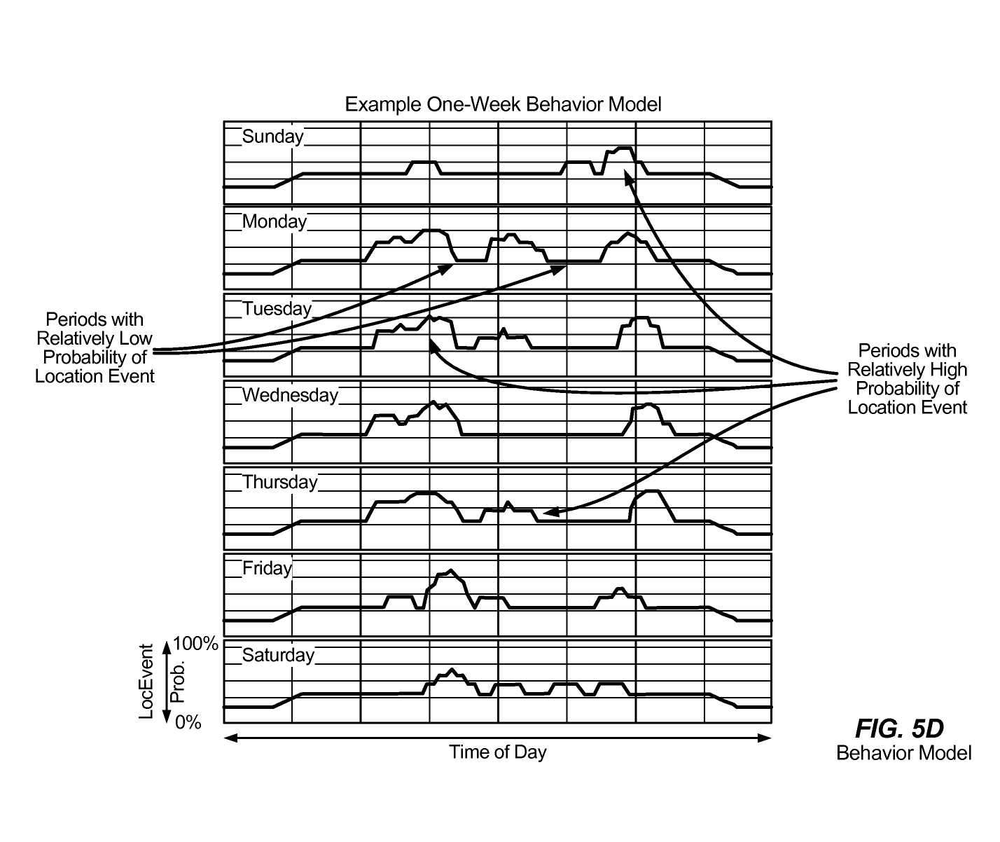

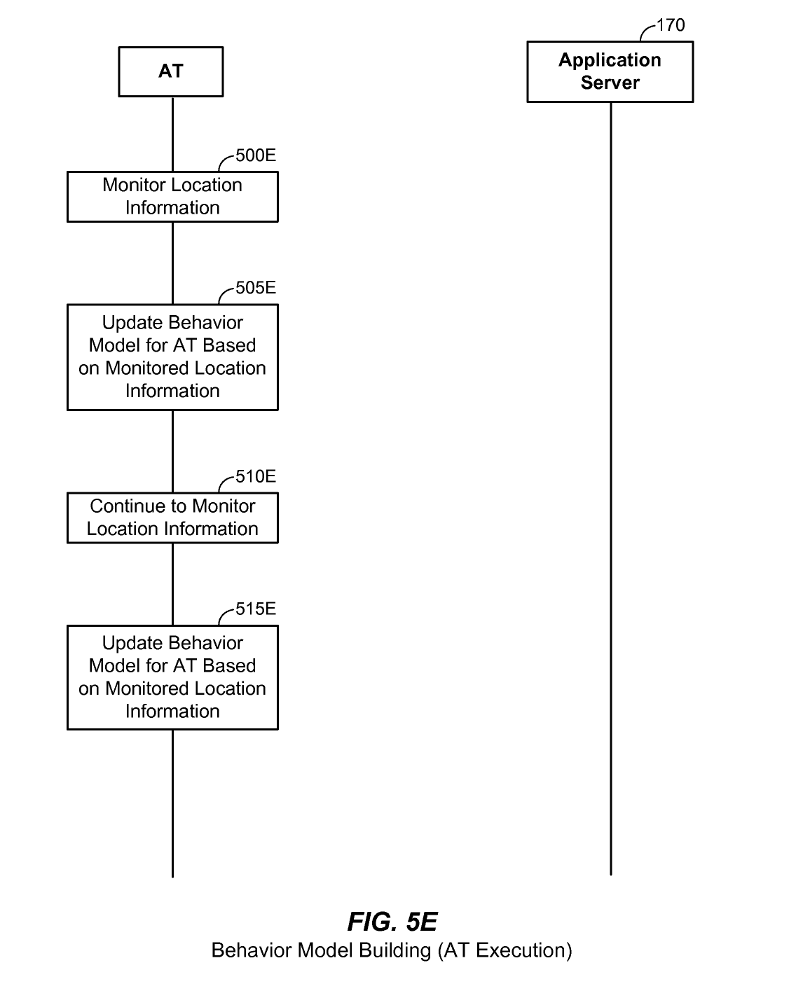

Returning to FIG. 4A, after 405, the given AT performing a location positioning procedure (e.g., a cellular and/or GPS positioning procedure) to determine if the given AT is currently located at the place, 410. In the embodiment of FIG. 4A, assume that the given AT determines itself to be located at the place at 410. After the determination of 410, the given AT begins or continues to monitor any information that can be indicative of location, 415 (e.g., sounds such as whether the user is snoring in bed, WiFi hotspot signals, a lack of motion as inferred through an accelerometer, etc.). The given AT can periodically report the monitored location information to the behavior modeling job module 235C of the application server 170, 420. The behavior modeling job module 235C uses the reported location information to generate and/or update a “place fingerprint” of the place, 425. While not shown in FIG. 4A, the given AT can also report the determination that the given AT is at the place in 415 as a location event for updating and/or establishing a behavior model, as will be discussed in more detail below with respect to FIG. 5A.

Referring to 425 of FIG. 4A, the place fingerprint can include any information by which the place can be identified, including but not limited to (i) geographic coordinates of the given AT, (ii) an environmental signature monitored by the given AT and/or (iii) a proximity of the given AT to one or more place-specific objects. For example, the given AT can report a plurality of geographic coordinates computed with GPS in 420, and the application server 170 can use to generate and/or update a place fingerprint with a geographic region (or geofence) for the place in 425. In another example, the given AT can report measured environmental conditions such as cellular base station pilot signals in range of the given at the place, ambient light, temperature or humidity at the place at a particular point in time, sounds and/or motion of the given AT, WiFi or Bluetooth signals in range of the given AT, and so on in 420, that the application server 170 can use this information to generate and/or update a place fingerprint for the place in 425. In another example, the given AT can report connections to particular computers or WiFi hotspots in 420, and the application server 170 can use this information to generate and/or update a place fingerprint for the place in 425.

Next, 415 through 425 repeat for a period of time until the given AT determines that the given AT is no longer at the place (e.g., based on a subsequent GPS and/or cellular positioning procedure), 430, which permits the given AT to stop building the place fingerprint for defining the place. While not shown in FIG. 4A, the given AT can also transmit a notification to the behavior modeling job module at the application server 170 based on the given AT's departure from the place qualifying as a location event, as will be discussed below in more detail with respect to FIG. 5A.

With respect to FIG. 4A, once the place fingerprints are generated, each place fingerprint is stored in the modeling database 245C so that the place fingerprints can be used to generate and/or update the behavior profile for the given AT, as will be discussed below with respect to FIGS. 5A through 5D. In FIG. 4A, the given AT monitors when the given AT is at a particular place so that location-specific information can be reported to the application server 170 such that the behavior modeling job module 235C can, over time, define characteristics that can be used to identify the particular place and form the place fingerprint. In FIG. 5A, instead of expanding on the characteristics that define the places, the place fingerprints defining the respective places are used to build a behavior profile that tracks location events (i.e., transitions of the given AT into and/or out of places). Accordingly, while operation of the given AT in FIG. 4A can be construed as a learning mode with respect to the place fingerprints of a plurality of places, FIG. 5A can be construed as a separate learning mode of the behavior profile.

Referring to FIG. 5A, assume that the user of the given AT has activated a learn mode for the behavior profile after one or more places are defined by their respective place fingerprints as described with respect to FIG. 4A. Accordingly, in 500A, the given AT monitors any information that can be indicative of location, and the given AT reports the monitored location information to the behavior modeling job module 235C of the application server 170, 505A, 500A and 505A are similar to 415 and 420 of FIG. 4A, respectively, except that the reported location information is used to determine a place at which the given AT is located, instead of trying to characterize a predetermined or known place as in FIG. 4A.

Referring to FIG. 5A, the behavior modeling job module 235C receives the reported location information from the given AT and generates and/or updates the behavior model for the given AT based on the reported location information, 510A. Example implementations of 510A are described in more detail below with respect to FIGS. 5B through 5D.

Turning back to the given AT, the given AT continues to monitors any information that can be indicative of location, 515A, and the given AT reports the monitored location information to the behavior modeling job module 235C of the application server 170, 520A. The behavior modeling job module 235C receives the reported location information from the given AT and updates the behavior model for the given AT based on the reported location information, 525A, and so on. Example implementations of 525A are described in more detail below with respect to FIGS. 5B through 5D. Accordingly, the process of FIG. 5A repeats until the learn mode for the behavior profile of the given AT is de-activated (either by the user of the given AT or by the application server 170).

FIG. 5B illustrates an example implementation of 510A and/or 525A of FIG. 5A in accordance with an embodiment of the present invention. Accordingly, FIG. 5B illustrates an example of updating a location event probability in the behavior model for the given AT based on the reported location information.

Referring to FIG. 5B, after receiving the reported location information from the given AT, the behavior modeling job module 235C loads an existing behavior model for the given AT and/or raw behavior data (i.e., previously reported location information from the given AT), 500B. For example, if the existing behavior model is loaded, the update to the behavior model can correspond to a modification or tweaking of the existing behavior model to produce the updated behavior model. Alternatively, the behavior modeling job module 235C can simply load the raw behavior data in order to re-generate the behavior model from scratch (while also using the newly reported location information). The existing behavior model and/or the raw behavior data may be loaded, in 500B, at the behavior modeling job module 235C from the modeling database 245C, in an example. As will be appreciated, the operation of 500B is described under the assumption that some earlier location information was reported by the given AT. Alternatively, if the AT's reported location information corresponds to an initial report of location information from the given AT, 500B can be omitted and the behavior model can be generated solely based on the initial reported location information.

Referring to FIG. 5B, the behavior modeling job module 235C determines a time associated with the given AT's reported location information, 505B. For example, the time determined at 505B can correspond to a time at which the reported location information is received at the behavior modeling job module 235C. Alternatively, the time determined at 505B can correspond to a time at which the location information was sent by the given AT and/or measured by the given AT, as indicated by one or more time-stamps contained in the report.

Next, the behavior modeling job module 235C determines whether the reported location information is indicative of a location event, 510B. As noted above, a location event occurs when the given AT is determined to enter a new place and/or to leave an old place. In 510B, if the behavior modeling job module 235C determines that the reported location information is indicative of a location event, the process advances to 515B whereby the behavior model for the given AT is updated to reflect an increased location event probability at the determined time. Of course, if the location event probability in the behavior profile for the determined time is already maxed-out, the probability need not be increased further in 515B. Turning back to 510B, if the behavior modeling job module 235C determines that the reported location information is not indicative of a location event, the process advances to 520B whereby the behavior model for the given AT is updated to reflect a decreased location event probability for the determined time. Of course, if the location event probability in the behavior profile for the determined time is already minimized, the probability need not be decreased further in 520B.

FIG. 5C illustrates an example implementation of 510B of FIG. 5B in accordance with an embodiment of the present invention. Accordingly, FIG. 5C illustrates an example of detecting whether a location event has occurred based on a place transition determination.

Referring to FIG. 5C, at some point before 510B, assume that the behavior modeling job module 235C defines a place fingerprint for each of a plurality of places of relevance to the user of the given AT, 500C. In the example of FIG. 5C, further assume that the place fingerprint is defined by one or more of (i) a defined geographical region, (ii) an environmental signature and/or (iii) a proximity to one or more place-specific objects. As an example, 500C of FIG. 5C can correspond to an earlier execution of the process of FIG. 4A as described above.

Advancing to 510B of FIG. 5B within the example of FIG. 5C, the behavior modeling job module 235C compares the given AT's reported location information with the place fingerprint of each of the plurality of places, 505C. Based on the comparison from 505C, in 510C, the behavior modeling job module 235C either (i) identifies a place associated with a matching fingerprint or (ii) determines that none of the place fingerprints match the given AT's reported location information. For example, if the given AT's reported location information corresponds to a geographic coordinate, the behavior modeling job module 235C can compare the reported geographic coordinate to geographic regions among the place fingerprints (if any) to determine if a match is present. In another example, if the given AT's reported location information corresponds to an indication that the given AT is in range of a particular WiFi hotspot, the behavior modeling job module 235C can compare the reported WiFi hotspot indication to WiFi hotspots associated with the place fingerprints (if any) to determine if a match is present. In another example, if the given AT's reported location information corresponds to an indication that the given AT is connected to a particular personal computer (PC), the behavior modeling job module 235C can compare the reported PC connection to PCs that are associated with the place fingerprints (if any) to determine if a match is present.

After determining a matching place in 510C (or determining that no matching place was present), the behavior modeling job module 235C loads results from a previous place determination procedure, 515C. In other words, in 515C, the behavior modeling job module 235C loads either the previous place at which the given AT was located or else loads an indicator that the given AT was previously not in any of the places.

Referring to FIG. 5C, in 520C, the behavior modeling job module 235C compares the results of 510C with the previous results loaded at 515C to determine whether a place transition has occurred. For example, if the place determined at 510C is different than the previous place loaded at 515C, the given AT is determined to have transitioned between places at 520C. In another example, if the given AT is determined to be outside of any of the places at 510C and the given AT was previously determined to be at a given place at 515C, the given AT is determined to have transitioned outside of the given place at 520C. In another example, if the given AT is determined to be at a given place at 510C and the given AT was previously determined to be outside of any of the places at 515C, the given AT is determined to have transitioned into the given place at 520C. If the behavior modeling job module 235C determines a place transition has occurred in 520C, then the behavior modeling job module 235C determines a location event has occurred at 525C. Otherwise, if the behavior modeling job module 235C determines a place transition has not occurred in 520C, then the behavior modeling job module 235C determines a location event has not occurred at 530C.

FIG. 5D illustrates an example of the behavior profile that is generated for the given AT during the process of FIG. 5A in accordance with an embodiment of the invention. Referring to FIG. 5D, the behavior model models the probabilities of location events occurring at the given AT during a one-week period. In FIG. 5D, for each day of the week, an x-axis is shown as representative of the time of day and the y-axis is shown as representative of a probability of a location event. As will be appreciated, the data shown in FIG. 5D may be for a “typical” or averaged week and may actually be based on AT behavior over a plurality of weeks. Thus, as an example, the probability of a location event is high on Monday through Friday during the user's commute to/from work (e.g., 8 AM-9 AM and 5 PM-6 PM), the probability of a location event is relatively low on Monday through Friday during work hours (e.g., 9:30 AM-4:30 PM) because the user is typically at his/her desk at work, the probability of a location event is low each day of the week during late-night hours (e.g., 11 PM-6 AM) because the user is usually at home asleep, and so on.

While FIGS. 5A through 5D are each directed to examples of behavior model generation whereby the given AT reports monitored location information to the application server 170 so that the application server 170 can remotely generate the behavior model, it will be appreciated that an AT with relatively high processing power could also perform the functionality described above as implemented at the application serve 170. In a scenario where the behavior model is generated and/or updated locally at the given AT, system resources can be conserved because the given AT need not establish a traffic channel with the RAN 120 for sending the location reports to the application server 170, in an example.

Accordingly, FIG. 5E illustrates an alternatively execution of the process of FIG. 5A whereby the behavior model is generated independently at the given AT without direct interaction with the application server 170.

Referring to FIG. 5E, the given AT monitors any information that can be indicative of location, 500E. Next, instead of reporting the monitored location information to the behavior modeling job module 235C of the application server 170 as in 505A of FIG. 5A, the application server 170 instead updates and/or generates the given AT's behavior model based on the monitored location information in 505E (e.g., similar 510A of FIG. 5A, except for being executed at the given AT). 500E and 505E then repeat a given number of times, as shown in 510E and 515E, respectively. Accordingly, it will be appreciated that FIG. 5B represents an example implementation of FIGS. 505E and/or 515E as executed at the given AT, and so on.

While FIGS. 4A through 5E illustrates examples of procedures associated with generating and updating the behavior profile of the given AT, FIGS. 6A and 6B illustrate alternative examples of provisioning the given AT with the behavior profile. In particular, FIG. 6A illustrates an AT-initiated provisioning operation, and FIG. 6B illustrates a server-initiated provisioning operation.

Referring to FIG. 6A, the given AT determines to update its behavior profile on the given AT, 600A. For example, the determination of 600A may be triggered at the end of the learn mode for the behavior model (i.e., after the process of FIG. 5A), in an example. Alternatively, the determination of 600A may be performed in a time-based manner (e.g., once per week, once per month, etc.) and/or an event-triggered manner (e.g., an existing behavior profile is exhibiting poor predictive performance associated with location events, the user of the given AT or a client application on the given AT explicitly requests an update to the behavior model, etc.).

After determining to update the behavior model on the given AT in 600A, the given AT transmits a request for the behavior model to the behavior modeling service module 240C in 605A. The behavior modeling service module 240C receives the request and issues its own request for the stored behavior model from the modeling database 245C on behalf of the given AT, 610A. The modeling database 245C provides the behavior modeling service module 240C with the stored behavior model, 615A, and the behavior modeling service module 240C sends the behavior model to the given AT, 620A. The given AT receives the behavior model from the behavior modeling service module 240C and updates the behavior model on the given AT, 625A. If the behavior model received by the given AT at 620A is a first instance of the behavior model provisioned to the given AT, the behavior model may simply be stored in memory at the given AT in 625A. Alternatively, if the behavior model received by the given AT at 620A is supplemental to an earlier behavior model provisioned to the given AT, the behavior model received at 620A may replace the earlier behavior model in 625A.

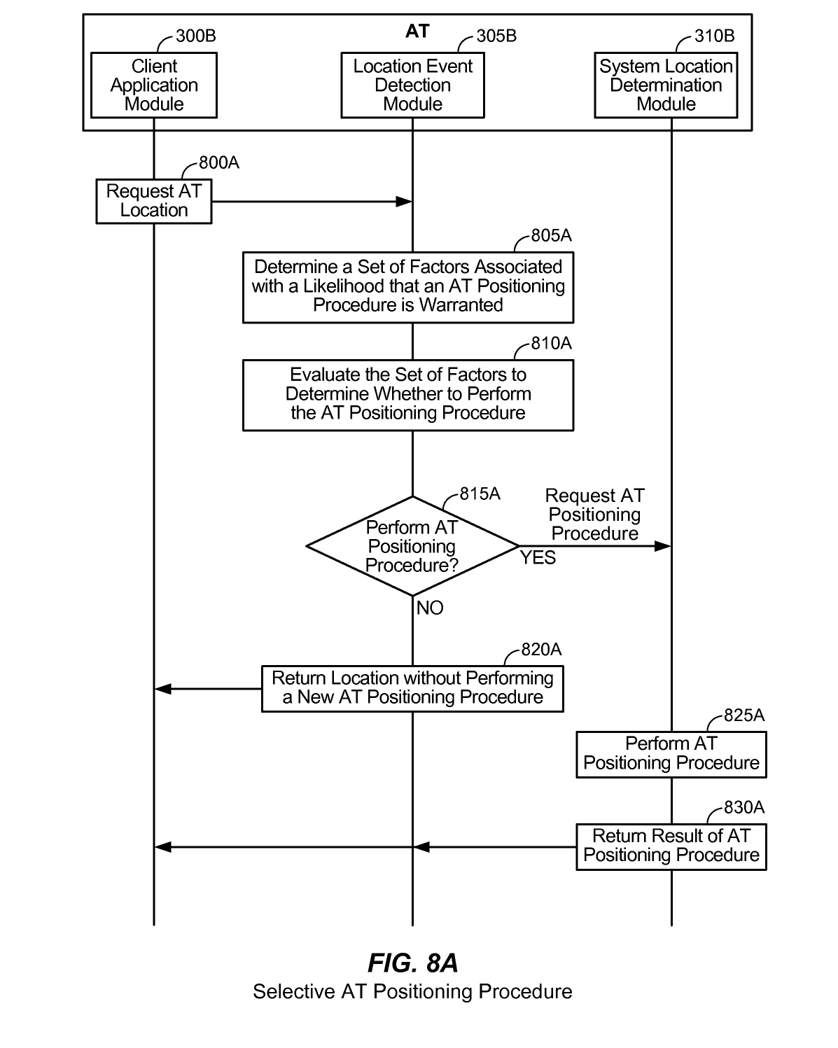

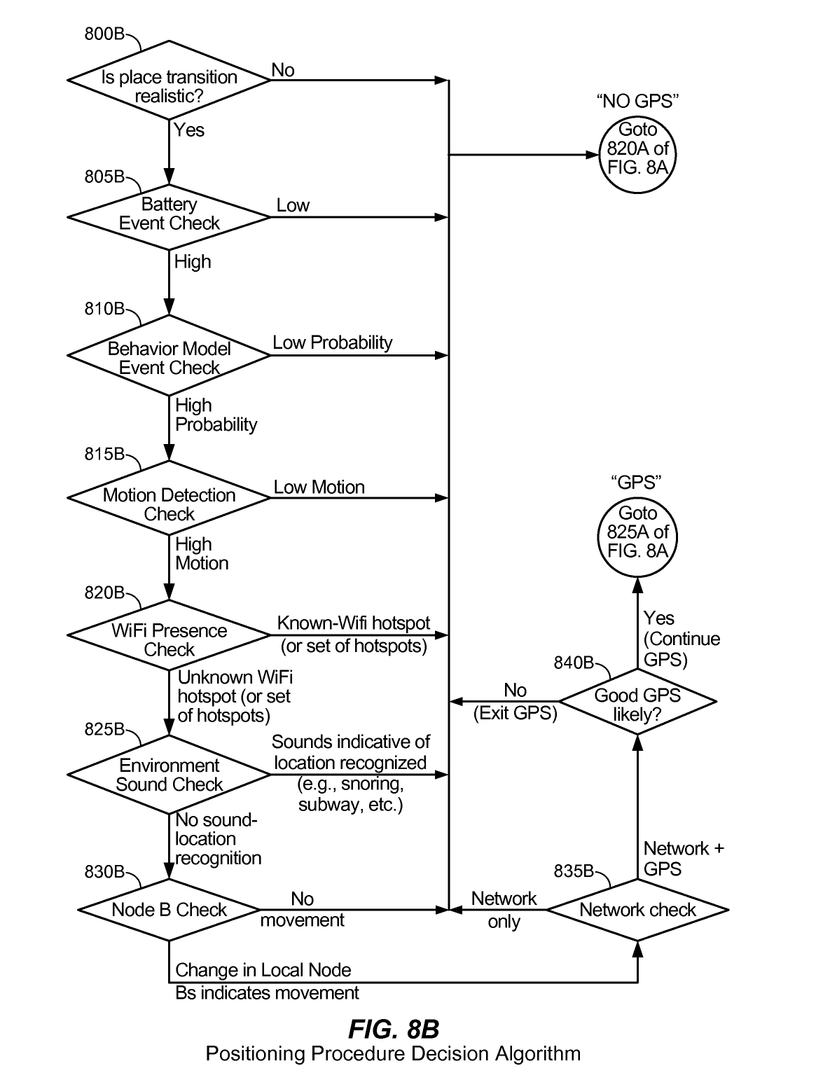

After updating the behavior model on the given AT in 625A, the given AT executes a power control procedure based on the updated behavior profile, 630A. An example of the power control procedure of 630A is described in greater detail below with respect to FIGS. 7 through 8B.

Referring to FIG. 6B, unlike FIG. 6A, the behavior modeling service module 240C determines to update the behavior profile on the given AT, 600B. For example, the determination of 600B may be triggered at the end of the learn mode for the behavior model (i.e., after the process of FIG. 5A), in an example. Alternatively, the determination of 600B may be performed in a time-based manner (e.g., once per week, once per month, etc.) and/or an event-triggered manner (e.g., the behavior profile has undergone an update at the application server 170 by the behavior modeling job module 235C and needs to be synchronized with the behavior model at the given AT, etc.). After the determination of 600B, 605B through 625B correspond to 610A through 630A of FIG. 6A, respectively, and as such will not be described further for the sake of brevity.

As will be appreciated, FIGS. 6A and 6B relate to behavior model retrieval by the given AT where the application server 170 hosts the behavior model and then distributes the behavior model to the given AT. This is consistent with the server-based behavior model generation procedures described above with respect to FIGS. 5A through 5D. However, in the example of FIG. 5E, the given AT generates the behavior model locally, such that the procedures of FIGS. 6A and/or 6D can be omitted and the stored behavior model can simply be loaded from memory at the given AT.

FIG. 7 illustrates an example of a power control procedure based on the behavior model implemented at the given AT in accordance with an embodiment of the invention. Specifically, the power control procedure of FIG. 7 relates to the behavior profile used in part to make a decision, at the given AT, with regard to whether to invoke a relatively power intensive positioning procedure (e.g., GPS, hybrid cellular/GPS, etc.) when the location of the given AT is requested by the client application module 300B.

Referring to FIG. 7, the client application module 300B issues a request for the location of the given AT to the location event detection module 305B, 700. For example, the client applicant module 300B can correspond to a navigation application on the given AT and the request issued by at 700 can be triggered by a request from the user of the given AT for directions. The location event detection module 305B receives the request for the given AT's location from the client application module 300B and loads the behavior model, 705. For example, the behavior model loaded at 705 may be generated as shown above with respect to FIGS. 4A through 5E and may be provisioned at the given AT in accordance with FIG. 6A or FIG. 6B.

Referring to FIG. 7, in addition to loading the behavior model at 705, the location event detection module 305B also determines a current time, 710. In 710, the time can be acquired in any well-known manner such as by querying an internal clock of the given AT and/or via a time synchronization procedure between the given AT and a cellular network. In 715, the location event detection module 305B determines the probability of a location event for the current time based on the behavior model's location event probability expectation for the current time. For example, with respect to the example behavior model from FIG. 5D, in 715, the location event detection module 305B may load a probability from the behavior model that corresponds to the same day of the week and time as the current time from 710. If the current time is 7 PM on Tuesday, then the location event detection module 305B looks up the location event probability at 7 PM on Tuesday in the behavior model, for instance.

Referring to FIG. 7, the location event detection module 305B can also optionally evaluate secondary factors to adjust or weight the location event probability determined at 715. For example, the user of the given AT may be at home 99% of the time on Thursday at 4 AM in the morning. However, the user may be on vacation, the user may be working late at work or the user may have a medical emergency such that the location event detection module 305B may try to corroborate the location event probability with secondary environmental factors, in an example. For example, a light sensor may be expected to detect low ambient light at Thursday at 4 AM based on an expectation that the user is probably asleep at home. By contrast, if the light sensor detects a high amount of light, it is possible that the light is daylight and the user is on vacation in another time zone or is not home for other reasons. Similarly, if an accelerometer on the given AT detects high-speed motion, the user is likely to be navigating between places and the high-motion indication can be used to override a low location threshold probability. Alternatively, a disconnection from a WiFi hotspot and/or cellular base station, such that the user is likely to be navigating between places and the high-motion indication can be used to override a low location threshold probability.

In a further example, a calendar application on the given AT may be modified by the user to indicate that the user is going to be out-of-town on a given weekend. If so, this information may be evaluated by the location event detection module 305B to increase a location event probability because the user's “normal” routine is not being followed.

Accordingly, in 720, the location event detection module 305B determines one or more secondary factors (e.g., ambient light, temperature, motion, calendar information, etc.) and then, if necessary, adjusts the location event probability from 715 based on the determined secondary factors, 725. Again, 720 and 725 are optional operations in FIG. 7.

In 730, the location event detection module 305B determines whether the determined location event probability is above a given threshold. If the location event detection module 305B determines that the location event probability is not above the given threshold, the location event detection module 305B returns a given location as the given AT's location without performing a new AT positioning procedure (e.g., GPS, etc.), 735. For example, the given location returned to the client application module 300B can correspond to a previous location determined for the given AT based on a previous AT positioning procedure, or a default location associated with a place at which the given AT is predicted to be located (e.g., such as a center-point of a given geographic region that defines the place at which the given AT is predicted to be located based on the behavior profile). As will be appreciated, refraining from performing the AT positioning procedure at 735 saves power at the given AT and extends battery life.

Returning to 730, if the location event detection module 305B determines that the location event probability is above the given threshold, the current location of the given AT cannot be predicted with a high level of certainty such that the location event detection module 305B requests that the system location determination module 310B perform a more accurate AT positioning procedure. At 740, the system location determination module 310B performs the AT positioning procedure and then, at 745, the system location determination module 310B returns the result of the AT positioning to the location event detection module 305B and the client application module, 300B.

The embodiments described above with respect to FIGS. 4A through 7 relate to the generation a behavior model and executing a power control procedure related to selectively invoking a positioning procedure based in part on the behavior model. However, in other embodiments of the invention, the behavior model can be optional or even omitted altogether. As will be described below with respect to FIGS. 8A-8B, other embodiments include an evaluation of a set of internal and/or environmental factors in addition to (or in place of) the behavior model in order to decide whether or not to invoke a relatively high-powered positioning procedure of the given AT, such as GPS.

Referring to FIG. 8A, the client application module 300B issues a request for the location of the given AT to the location event detection module 305B, 800A (e.g., similar to 700 of FIG. 7). The location event detection module 305B receives the request for the given AT's location from the client application module 300B and determines a set of factors associated with a likelihood that an AT positioning procedure is warranted, 805A. Examples of the set of factors that can be determined at 805A are given below with respect to FIG. 8B. The location event detection module 305B evaluates the set of factors, 810A, and based on this evaluation, the location event detection module 305B determines whether to perform the AT positioning procedure, 815A.

If the location event detection module 305B determines not to perform the AT positioning procedure in 815A, the location event detection module 305B returns a given location as the given AT's location without performing a new AT positioning procedure (e.g., GPS, etc.), 820A (e.g., as in 735 of FIG. 7). Otherwise, if the location event detection module 305B determines to perform the AT positioning procedure in 815A, the location event detection module 305B issues an AT positioning procedure request to the system location determination module 310B, and the system location determination module 310B performs the AT positioning procedure, 825A. Then, at 830A, the system location determination module 310B returns the result of the AT positioning to the location event detection module 305B and the client application module, 300B.

Referring to FIG. 8A, in an example, blocks 805A, 810A and 815A can be executed in an iterative fashion, such that a single factor is determined at 805A and then evaluated at 810A, with a next factor being determined and evaluated in the event that the previous determined/evaluated factor did not result in a decision, at 815A, to bypass the AT positioning procedure. In this example, the relatively power-intensive AT positioning procedure (e.g., GPS) is performed only if each of the set of factors is deemed insufficient to infer a probability of a location event and/or a place at which the given AT is currently located, which conserves power by reducing the number of times the given AT is required to execute the relatively power-intensive AT positioning procedure. An example implementation of blocks 805A, 810A and 815A performed in an iterative manner is given below with respect to FIG. 8B.

Referring to FIG. 8B, the given AT performs a general evaluation of whether a place transition is realistic, 800B. If the given AT determines that a place transition is not realistic, the decision procedure of FIG. 8B exits and the process advances to 820A of FIG. 8A, such that the relatively power-intensive AT positioning procedure is bypassed or skipped. Otherwise, the process advances to 805B.

Referring to FIG. 8B, in 805B, the given AT checks a current battery level of the given AT and compares the current battery level against a threshold. If the battery level is below the threshold such that it is infeasible or impractical to perform a power-intensive positioning procedure, the decision procedure of FIG. 8B exits and the process advances to 820A of FIG. 8A, such that the relatively power-intensive AT positioning procedure is bypassed or skipped. Otherwise, the process advances to 810B.

Referring to FIG. 8B, in 810B, the given AT loads and evaluates the behavior model as discussed above with respect to blocks 705 through 725 of FIG. 7. Accordingly, the location event probability is compared against a probability threshold. If the location event probability is below the threshold, the decision procedure of FIG. 8B exits and the process advances to 820A of FIG. 8A, such that the relatively power-intensive AT positioning procedure is bypassed or skipped. Otherwise, the process advances to 815B.

Referring to FIG. 8B, in 815B, the given AT determines its level of motion and compares its determined level of motion with a motion threshold. For example, the determined level of motion can correspond to a speed of the given AT as determined by an accelerometer. In another example, motion can be inferred by a rate at which the given AT is leaving the range of certain WiFi hotspots and/or cellular base stations and detecting new WiFi hotspots and/or cellular base stations (e.g., if the user is driving a car with the given AT, these detections/disconnections can occur frequently). If the determined level of motion is below the motion threshold, such that the location of the given AT can be inferred and/or a location event is deemed unlikely, the decision procedure of FIG. 8B exits and the process advances to 820A of FIG. 8A, such that the relatively power-intensive AT positioning procedure is bypassed or skipped. Otherwise, the process advances to 820B.

Referring to FIG. 8B, in 820B, the given AT performs a WiFi presence check. For example, the given AT can monitor local WiFi beacon signals carrying SSIDs of local WiFi connections and then compare the local SSIDs with a stored set of SSIDs. If the local SSIDs are known (i.e., they match one or more of the place fingerprints for a pre-defined place), such that the location of the given AT can be inferred, the decision procedure of FIG. 8B exits and the process advances to 820A of FIG. 8A, such that the relatively power-intensive AT positioning procedure is bypassed or skipped (e.g., because the place can be inferred from the local SSIDs). Otherwise, the process advances to 825B.

Referring to FIG. 8B, in 825B, the given AT performs an environmental or local sound check. For example, the given AT can monitor local sounds and determine whether or not the local sounds are indicative are known (i.e., they match one or more of the place fingerprints for a pre-defined place). For example, if the given AT monitors snoring with a voice signature that matches the user's previous snoring habits and the time of day corresponds to a time at which the user typically sleeps, the given AT may be inferred as located at a particular place, such as the user's home. If the local sound can be used to infer the location of the given AT, the decision procedure of FIG. 8B exits and the process advances to 820A of FIG. 8A, such that the relatively power-intensive AT positioning procedure is bypassed or skipped (e.g., because the place can be inferred from the local SSIDs). Otherwise, the process advances to 830B.

Referring to FIG. 8B, in 830B, the given AT performs a cell tower (or base station/Node B) check. For example, if three base station pilot signals are detected by the given AT, the given AT knows its location corresponds to an overlapping portion of the coverage areas of the three base stations. Thereby, the given AT's location can be roughly approximated. If this rough approximation of the location of the given AT is available (i.e., the base stations are in range of the given AT) and the precision of the location estimate is sufficient to satisfy the location request, the decision procedure of FIG. 8B exits and the process advances to 820A of FIG. 8A, such that the relatively power-intensive AT positioning procedure is bypassed or skipped (e.g., because the place can be inferred from the local SSIDs). Otherwise, the process advances to 835B.

Referring to FIG. 8B, in 835B, the given AT performs a network check to determine whether a network (or terrestrial) based positioning procedure is available. If the network or cellular positioning procedure is available, the decision procedure of FIG. 8B exits and the process advances to 820A of FIG. 8A, such that the relatively power-intensive AT positioning procedure is bypassed or skipped (e.g., because the place can be inferred from the local SSIDs). Otherwise, the process advances to 840B.

Referring to FIG. 8B, in 840B, the given AT either attempts to perform a hybrid cellular/GPS based positioning procedure or an exclusive GPS positioning procedure. In preparation for executing the GPS-based positioning procedure, a GPS manager module (not shown) is loaded on the given AT and determines whether an accurate GPS position is likely to result from the GPS positioning procedure. For example, if three GPS positioning procedures have already resulted in wildly inaccurate location estimates, the GPS manager module may assume that a subsequent GPS positioning procedure is likely to be another waste of time. If the GPS manager module determines that a valid or satisfactory GPS location estimate is unlikely to be obtained, the decision procedure of FIG. 8B exits and the process advances to 820A of FIG. 8A, such that the relatively power-intensive AT positioning procedure is bypassed or skipped (e.g., because the place can be inferred from the local SSIDs). Otherwise, the process advances to 825A of FIG. 8A and the given AT performs the power-intensive AT positioning procedure.

As will be appreciated, FIG. 8B merely illustrates one example order of evaluation for the set of factors that are determined at 805A of FIG. 8A. The example order shown in FIG. 8B can be rearranged in other embodiments, and additional factors can be included (or excluded) from the specific example discussed above.

Further, the example of FIG. 8A is described such that the set of factors is evaluated each time the client application module 300B requests the location of the given AT. However, in another embodiment, a reduced subset or an increased set of factors can be evaluated based on a frequency at which the AT's location is requested. For example, if the given AT's location is requested frequently and certain factors consistently fail to be relevant to the decision of FIG. 8B, these parameters can be omitted for subsequent location requests. Alternatively, new factors can be added in a similar scenario (i.e., certain factors are not helping, so try others) and/or based on an associated factor being relevant for an earlier execution of blocks 805A through 815A (or FIG. 8B) (i.e., certain factors are helping, so try other related factors).

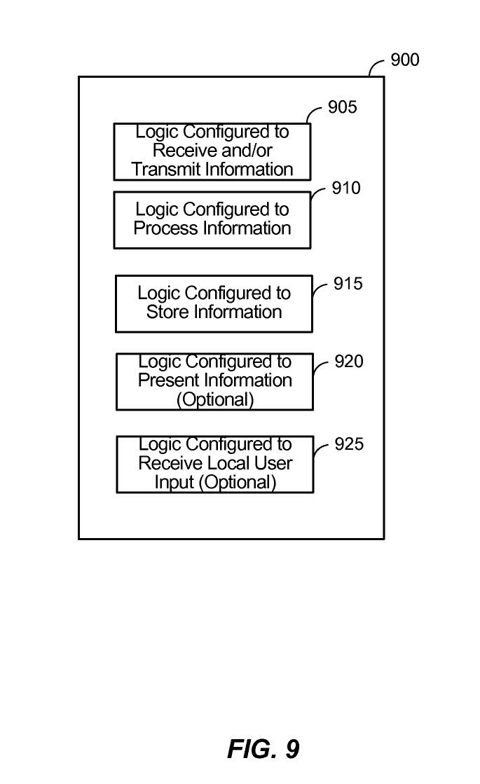

FIG. 9 illustrates a communication device 900 that includes logic configured to perform functionality. The communication device 900 can correspond to any of the above-noted communication devices, including but not limited to ATs 102, 108, 110, 112 or 200, Node Bs or base stations 120, the RNC or base station controller 122, a packet data network end-point (e.g., SGSN, GGSN, etc.), any of the servers 170 or 180, etc. Thus, communication device 900 can correspond to any electronic device that is configured to communicate with (or facilitate communication with) one or more other entities over a network.

Referring to FIG. 9, the communication device 900 includes logic configured to receive and/or transmit information 905. In an example, if the communication device 900 corresponds to a wireless communications device (e.g., AT 200, Node B 124, etc.), the logic configured to receive and/or transmit information 905 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 905 can correspond to a wired communications interface (e.g., a serial connection, a USB or Firewire connection, an Ethernet connection through which the Internet 175 can be accessed, etc.). Thus, if the communication device 900 corresponds to some type of network-based server (e.g., SGSN, GGSN, application server 170, etc.), the logic configured to receive and/or transmit information 905 can correspond to an Ethernet card, in an example, that connects the network-based server to other communication entities via an Ethernet protocol. In a further example, the logic configured to receive and/or transmit information 905 can include sensory or measurement hardware by which the communication device 900 can monitor its local environment (e.g., an accelerometer, a temperature sensor, a light sensor, an antenna for monitoring local RF signals, etc.). The logic configured to receive and/or transmit information 905 can also include software that, when executed, permits the associated hardware of the logic configured to receive and/or transmit information 905 to perform its reception and/or transmission function(s). However, the logic configured to receive and/or transmit information 905 does not correspond to software alone, and the logic configured to receive and/or transmit information 905 relies at least in part upon hardware to achieve its functionality.

Referring to FIG. 9, the communication device 900 further includes logic configured to process information 910. In an example, the logic configured to process information 910 can include at least a processor. Example implementations of the type of processing that can be performed by the logic configured to process information 910 includes but is not limited to performing determinations, establishing connections, making selections between different information options, performing evaluations related to data, interacting with sensors coupled to the communication device 900 to perform measurement operations, converting information from one format to another (e.g., between different protocols such as .wmv to .avi, etc.), and so on. For example, the processor included in the logic configured to process information 910 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 910 can also include software that, when executed, permits the associated hardware of the logic configured to process information 910 to perform its processing function(s). However, the logic configured to process information 910 does not correspond to software alone, and the logic configured to process information 910 relies at least in part upon hardware to achieve its functionality.

Referring to FIG. 9, the communication device 900 further includes logic configured to store information 915. In an example, the logic configured to store information 915 can include at least a non-transitory memory and associated hardware (e.g., a memory controller, etc.). For example, the non-transitory memory included in the logic configured to store information 915 can correspond to RAM memory, flash memory, ROM memory, EPROM memory, EEPROM memory, registers, hard disk, a removable disk, a CD-ROM, or any other form of storage medium known in the art. The logic configured to store information 915 can also include software that, when executed, permits the associated hardware of the logic configured to store information 915 to perform its storage function(s). However, the logic configured to store information 915 does not correspond to software alone, and the logic configured to store information 915 relies at least in part upon hardware to achieve its functionality.

Referring to FIG. 9, the communication device 900 further optionally includes logic configured to present information 920. In an example, the logic configured to display information 920 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 900. For example, if the communication device 900 corresponds to AT 200 as shown in FIG. 3, the logic configured to present information 920 can include the display 224. In a further example, the logic configured to present information 920 can be omitted for certain communication devices, such as network communication devices that do not have a local user (e.g., network switches or routers, remote servers, etc.). The logic configured to present information 920 can also include software that, when executed, permits the associated hardware of the logic configured to present information 920 to perform its presentation function(s). However, the logic configured to present information 920 does not correspond to software alone, and the logic configured to present information 920 relies at least in part upon hardware to achieve its functionality.

Referring to FIG. 9, the communication device 900 further optionally includes logic configured to receive local user input 925. In an example, the logic configured to receive local user input 925 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 900. For example, if the communication device 900 corresponds to AT 200 as shown in FIG. 3, the logic configured to receive local user input 925 can include the display 224 (if implemented a touch-screen), buttons 226, etc. In a further example, the logic configured to receive local user input 925 can be omitted for certain communication devices, such as network communication devices that do not have a local user (e.g., network switches or routers, remote servers, etc.). The logic configured to receive local user input 925 can also include software that, when executed, permits the associated hardware of the logic configured to receive local user input 925 to perform its input reception function(s). However, the logic configured to receive local user input 925 does not correspond to software alone, and the logic configured to receive local user input 925 relies at least in part upon hardware to achieve its functionality.

Referring to FIG. 9, while the configured logics of 905 through 925 are shown as separate or distinct blocks in FIG. 9, it will be appreciated that the hardware and/or software by which the respective configured logic performs its functionality can overlap in part. For example, any software used to facilitate the functionality of the configured logics of 905 through 925 can be stored in the non-transitory memory associated with the logic configured to store information 915, such that the configured logics of 905 through 925 each performs their functionality (i.e., in this case, software execution) based in part upon the operation of software stored by the logic configured to store information 905. Likewise, hardware that is directly associated with one of the configured logics can be borrowed or used by other configured logics from time to time. For example, the processor of the logic configured to process information 910 can format data into an appropriate format before being transmitted by the logic configured to receive and/or transmit information 905, such that the logic configured to receive and/or transmit information 905 performs its functionality (i.e., in this case, transmission of data) based in part upon the operation of hardware (i.e., the processor) associated with the logic configured to process information 910. Further, the configured logics or “logic configured to” of 905 through 925 are not limited to specific logic gates or elements, but generally refer to the ability to perform the functionality describe herein (either via hardware or a combination of hardware and software). Thus, the configured logics or “logic configured to” of 905 through 925 are not necessarily implemented as logic gates or logic elements despite sharing the word “logic”. Other interactions or cooperation between the configured logics 905 through 925 will become clear to one of ordinary skill in the art from a review of the embodiments described above.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a subscriber terminal (e.g., access terminal). In the alternative, the processor and the storage medium may reside as discrete components in a subscriber terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating an access terminal, comprising:
configuring a geofence associated with a user-defined place;
determining, based on the configured geofence, that the access terminal is positioned at the user-defined place;
measuring location information associated with the access terminal while the access terminal is determined to be positioned at the user-defined place; and
reporting the location information to a server to refine a place fingerprint that is configured to characterize the user-defined place.

2. The method of claim 1, further comprising:
determining, based on the configured geofence, that the access terminal is no longer positioned at the user-defined place; and
ceasing the reporting step in response to the determination that the access terminal is no longer positioned at the user-defined place.

3. The method of claim 1, wherein the configuring, determining, measuring and reporting steps are performed while the access terminal is operating in a learning mode for place characterization.

4. The method of claim 1, wherein the location information includes measured environmental conditions associated with an operating environment of the access terminal.

5. The method of claim 4, wherein the measured environmental conditions are associated with one or more of (i) cellular base station pilot signals, WiFi signals or Bluetooth signals, (ii) ambient light, temperature or humidity, (iii) motion or acceleration of the access terminal.

6. A method of operating a server, comprising:
receiving location information associated with an access terminal while the given access terminal is positioned at a user-defined place;
updating a place fingerprint configured to identify the user-defined place based on the received location information.

7. The method of claim 6,
wherein a user of the access terminal registers the user-defined place with the server, and
wherein the location information begins to be received from the access terminal after the registration.

8. The method of claim 6, wherein the location information includes measured environmental conditions associated with an operating environment of the access terminal.

9. The method of claim 8, wherein the measured environmental conditions are associated with one or more of (i) cellular base station pilot signals, WiFi signals or Bluetooth signals, (ii) ambient light, temperature or humidity, (iii) motion or acceleration of the access terminal.

10. A method of operating a communications device, comprising:
obtaining location information associated with an access terminal, the access terminal associated with a set of user-defined places that are respectively identifiable by a set of place fingerprints;
determining, based on the location information and the set of place fingerprints, whether a location event has occurred with respect to the access terminal, wherein location events for the access terminal are characterized by the access terminal transitioning into and/or out of at least one of the set of user-defined places; and
updating a behavior model for the access terminal based on the determination.

11. The method of claim 10, wherein the obtaining, determining and updating steps are performed by the access terminal.

12. The method of claim 10, wherein the obtaining, determining and updating steps are performed by a server.

13. The method of claim 10, wherein the behavior model is indicative of a probability of location event occurrence over a period of time.

14. The method of claim 13,
wherein the determining step determines that the location event has occurred,
wherein, based on the determination that the location event has occurred, the updating step increases the probability of location event occurrence for a time in the behavior model that is associated with the location information.

15. The method of claim 14, wherein the time in the behavior model corresponds to (i) a time at which the location information was obtained by the obtaining step, or (ii) for a time at which the location information was measured at the access terminal.

16. The method of claim 13,
wherein the determining step determines that the location event has not occurred,
wherein, based on the determination that the location event has not occurred, the updating step decreases the probability of location event occurrence for a time in the behavior model that is associated with the location information.

17. The method of claim 16, wherein the time in the behavior model corresponds to (i) a time at which the location information was obtained by the obtaining step, or (ii) for a time at which the location information was measured at the access terminal.

18. The method of claim 10, wherein the determining step includes:
comparing the location information with a set of place fingerprints associated with the set of user-defined places.

19. The method of claim 18, wherein the determining step further includes:
determining that the location event has occurred (i) if the comparison indicates that the location information matches one of the set of place fingerprints and the access terminal was previously determined not to be positioned at a user-defined place associated with the matching place fingerprint, or (ii) if the comparison indicates that the location information does not match a given one of the set of place fingerprints and the access terminal was previously determined to be positioned at a user-defined place associated with the given non-matching place fingerprint.

20. The method of claim 18, wherein the determining step further includes:
determining that the location event has not occurred (i) if the comparison indicates that the location information matches one of the set of place fingerprints and the access terminal was previously determined to be positioned at a user-defined place associated with the matching place fingerprint, or (ii) if the comparison indicates that the location information does not match any of the set of place fingerprints and the access terminal was previously determined not to be positioned at a user-defined place associated with any of the set of place fingerprints.

21. A method of operating an access terminal, comprising:
receiving a request for a location of the access terminal;
loading a behavior model that is indicative of a probability of location event occurrence for the access terminal over a period of time, wherein a location event for the access terminal is characterized by the access terminal transitioning into and/or out of at least one of a set of user-defined places;
determining a current probability of location event occurrence for the access terminal based at least in part on the behavior model; and
selecting between a higher power-consumption positioning procedure and one or more lower power-consumption positioning procedures for determining the requested location based on the determined current probability of location event occurrence for the access terminal.

22. The method of claim 21, wherein the request for the location of the access terminal originates from an application executing on the access terminal.

23. The method of claim 21, wherein the selecting step includes:
comparing the determined current probability of location event occurrence with a threshold;
selecting the higher power-consumption positioning procedure if the determined current probability of location event occurrence is above the threshold; and
selecting one of the lower power-consumption positioning procedures if the determined current probability of location event occurrence is not above the threshold.

24. The method of claim 21, wherein the selecting step selects the higher power-consumption positioning procedure, further comprising:
executing the higher power-consumption positioning procedure for the access terminal; and
returning an estimate of the access terminal's location based on the execution.

25. The method of claim 21, wherein the selecting step selects one of the lower power-consumption positioning procedures, further comprising:
executing the selected lower power-consumption positioning procedure for the access terminal; and
returning an estimate of the access terminal's location based on the execution.

26. The method of claim 21, wherein the higher power-consumption positioning procedure corresponds to a global positioning system (GPS) positioning procedure.

27. The method of claim 21, wherein the one or more lower power-consumption positioning procedures include:
returning a previous estimate of the access terminal's location, and
returning a location estimate associated with one of the set of user-defined places at which the access terminal is expected to be positioned.

28. The method of claim 21, further comprising:
receiving an updated version of the behavior model at the access terminal from a server.

29. The method of claim 28, wherein the updated version of the behavior model is received in response to a behavior model update request from the access terminal.

30. The method of claim 28, wherein the updated version of the behavior model is not explicitly requested by the access terminal.

31. The method of claim 28, wherein the updated version of the behavior model corresponds to the behavior model that is loaded during the loading step.

32. The method of claim 21, wherein the determining step includes:
generating an initial current probability of location event occurrence for the access terminal based on the behavior model;
obtaining a set of secondary factors associated with location event occurrence likelihood; and
adjusting the initial current probability of location event occurrence based on the set of secondary factors to produce the determined current probability of location event occurrence.

33. The method of claim 32, wherein the set of secondary factors includes ambient light and/or temperature conditions detected by the access terminal, speed or motion of the access terminal and/or calendar information.

34. A method of operating an access terminal, comprising:
receiving a request for a location of the access terminal;
determining a set of factors associated with a likelihood that a higher power-consumption positioning procedure for the access terminal is warranted, the set of factors including one or more of (i) a battery level of the access terminal, (ii) a behavior model indicative of a current probability of location event occurrence for the access terminal over a period of time, wherein a location event for the access terminal is characterized by the access terminal transitioning into and/or out of at least one of a set of user-defined places, (iii) motion or acceleration of the access terminal, (iv) presence or absence of WiFi signals, (v) ambient sound and/or (vi) availability of a terrestrial network positioning procedure; and
evaluating the set of factors to determine whether to estimate the requested location via the higher power-consumption positioning procedure one or more lower power-consumption positioning procedures.

35. The method of claim 34, wherein the request for the location of the access terminal originates from an application executing on the access terminal.

36. The method of claim 34, wherein the evaluating step determines to estimate the requested location via the one or more lower power-consumption positioning procedures unless each of the set of factors independently indicates that the higher power-consumption positioning procedure is warranted.

37. The method of claim 34,
wherein the battery level is among the set of factors, and
wherein the evaluating step determines to estimate the requested location via the one or more lower power-consumption positioning procedures if a current battery level of the access terminal is lower than a threshold.

38. The method of claim 34,
wherein the behavior model is among the set of factors, and
wherein the evaluating step determines to estimate the requested location via the one or more lower power-consumption positioning procedures if the current probability of location event occurrence is below a threshold.

39. The method of claim 34,
wherein the motion or acceleration of the access terminal is among the set of factors, and
wherein the evaluating step determines to estimate the requested location via the one or more lower power-consumption positioning procedures if the motion or acceleration of the access terminal is below a threshold.

40. The method of claim 34,
wherein the presence or absence of WiFi signals of the access terminal is among the set of factors, and
wherein the evaluating step determines to estimate the requested location via the one or more lower power-consumption positioning procedures if the presence or absence of WiFi signals indicates that the location of the access terminal can be proximately estimated.

41. The method of claim 34,
wherein the ambient sound is among the set of factors, and
wherein the evaluating step determines to estimate the requested location via the one or more lower power-consumption positioning procedures if the ambient sound indicates that the access terminal is unlikely to have moved from a previously estimated location.

42. The method of claim 34,
wherein the availability of a terrestrial network positioning procedure is among the set of factors, and
wherein the evaluating step determines to estimate the requested location via the availability of a terrestrial network positioning procedure if the availability of a terrestrial network positioning procedure is available.

43. An access terminal, comprising:
means for configuring a geofence associated with a user-defined place;
means for determining, based on the configured geofence, that the access terminal is positioned at the user-defined place;
means for measuring location information associated with the access terminal while the access terminal is determined to be positioned at the user-defined place; and
means for reporting the location information to a server to refine a place fingerprint that is configured to characterize the user-defined place.

44. A server, comprising:
means for receiving location information associated with an access terminal while the given access terminal is positioned at a user-defined place;
means for updating a place fingerprint configured to identify the user-defined place based on the received location information.

45. A communications device, comprising:
means for obtaining location information associated with an access terminal, the access terminal associated with a set of user-defined places that are respectively identifiable by a set of place fingerprints;
means for determining, based on the location information and the set of place fingerprints, whether a location event has occurred with respect to the access terminal, wherein location events for the access terminal are characterized by the access terminal transitioning into and/or out of at least one of the set of user-defined places; and
means for updating a behavior model for the access terminal based on the determination.

46. The communications device of claim 45, wherein the communications device corresponds to the access terminal.

47. The communications device of claim 45, wherein the communications device corresponds to a server in communication with the access terminal.

48. An access terminal, comprising:
means for receiving a request for a location of the access terminal;
means for loading a behavior model that is indicative of a probability of location event occurrence for the access terminal over a period of time, wherein a location event for the access terminal is characterized by the access terminal transitioning into and/or out of at least one of a set of user-defined places;
means for determining a current probability of location event occurrence for the access terminal based at least in part on the behavior model; and
means for selecting between a higher power-consumption positioning procedure and one or more lower power-consumption positioning procedures for determining the requested location based on the determined current probability of location event occurrence for the access terminal.

49. An access terminal, comprising:
means for receiving a request for a location of the access terminal;
means for determining a set of factors associated with a likelihood that a higher power-consumption positioning procedure for the access terminal is warranted, the set of factors including one or more of (i) a battery level of the access terminal, (ii) a behavior model indicative of a current probability of location event occurrence for the access terminal over a period of time, wherein a location event for the access terminal is characterized by the access terminal transitioning into and/or out of at least one of a set of user-defined places, (iii) motion or acceleration of the access terminal, (iv) presence or absence of WiFi signals, (v) ambient sound and/or (vi) availability of a terrestrial network positioning procedure; and
means for evaluating the set of factors to determine whether to estimate the requested location via the higher power-consumption positioning procedure one or more lower power-consumption positioning procedures.

50. An access terminal, comprising:
logic configured to configure a geofence associated with a user-defined place;
logic configured to determine, based on the configured geofence, that the access terminal is positioned at the user-defined place;
logic configured to measure location information associated with the access terminal while the access terminal is determined to be positioned at the user-defined place; and
logic configured to report the location information to a server to refine a place fingerprint that is configured to characterize the user-defined place.

51. A server, comprising:
logic configured to receive location information associated with an access terminal while the given access terminal is positioned at a user-defined place;
logic configured to update a place fingerprint configured to identify the user-defined place based on the received location information.

52. A communications device, comprising:
logic configured to obtain location information associated with an access terminal, the access terminal associated with a set of user-defined places that are respectively identifiable by a set of place fingerprints;
logic configured to determine, based on the location information and the set of place fingerprints, whether a location event has occurred with respect to the access terminal, wherein location events for the access terminal are characterized by the access terminal transitioning into and/or out of at least one of the set of user-defined places; and
logic configured to update a behavior model for the access terminal based on the determination.

53. The communications device of claim 52, wherein the communications device corresponds to the access terminal.

54. The communications device of claim 52, wherein the communications device corresponds to a server in communication with the access terminal.

55. An access terminal, comprising:
logic configured to receive a request for a location of the access terminal;
logic configured to load a behavior model that is indicative of a probability of location event occurrence for the access terminal over a period of time, wherein a location event for the access terminal is characterized by the access terminal transitioning into and/or out of at least one of a set of user-defined places;
logic configured to determine a current probability of location event occurrence for the access terminal based at least in part on the behavior model; and
logic configured to select between a higher power-consumption positioning procedure and one or more lower power-consumption positioning procedures for determining the requested location based on the determined current probability of location event occurrence for the access terminal.

56. An access terminal, comprising:
logic configured to receive a request for a location of the access terminal;
logic configured to determine a set of factors associated with a likelihood that a higher power-consumption positioning procedure for the access terminal is warranted, the set of factors including one or more of (i) a battery level of the access terminal, (ii) a behavior model indicative of a current probability of location event occurrence for the access terminal over a period of time, wherein a location event for the access terminal is characterized by the access terminal transitioning into and/or out of at least one of a set of user-defined places, (iii) motion or acceleration of the access terminal, (iv) presence or absence of WiFi signals, (v) ambient sound and/or (vi) availability of a terrestrial network positioning procedure; and
logic configured to evaluate the set of factors to determine whether to estimate the requested location via the higher power-consumption positioning procedure one or more lower power-consumption positioning procedures.

57. A non-transitory computer-readable medium containing instructions stored thereon, which, when executed by an access terminal, cause the access terminal to perform operations, the instructions comprising:
program code to configure a geofence associated with a user-defined place;
program code to determine, based on the configured geofence, that the access terminal is positioned at the user-defined place;
program code to measure location information associated with the access terminal while the access terminal is determined to be positioned at the user-defined place; and
program code to report the location information to a server to refine a place fingerprint that is configured to characterize the user-defined place.

58. A non-transitory computer-readable medium containing instructions stored thereon, which, when executed by a server, cause the server to perform operations, the instructions comprising:
program code to receive location information associated with an access terminal while the given access terminal is positioned at a user-defined place;
program code to update a place fingerprint configured to identify the user-defined place based on the received location information.

59. A non-transitory computer-readable medium containing instructions stored thereon, which, when executed by a communications device, cause the communications device to perform operations, the instructions comprising:
program code to obtain location information associated with an access terminal, the access terminal associated with a set of user-defined places that are respectively identifiable by a set of place fingerprints;
program code to determine, based on the location information and the set of place fingerprints, whether a location event has occurred with respect to the access terminal, wherein location events for the access terminal are characterized by the access terminal transitioning into and/or out of at least one of the set of user-defined places; and
program code to update a behavior model for the access terminal based on the determination.

60. The non-transitory computer-readable medium of claim 59, wherein the communications device corresponds to the access terminal.

61. The non-transitory computer-readable medium of claim 59, wherein the communications device corresponds to a server in communication with the access terminal.

62. A non-transitory computer-readable medium containing instructions stored thereon, which, when executed by an access terminal, cause the access terminal to perform operations, the instructions comprising:
program code to receive a request for a location of the access terminal;
program code to load a behavior model that is indicative of a probability of location event occurrence for the access terminal over a period of time, wherein a location event for the access terminal is characterized by the access terminal transitioning into and/or out of at least one of a set of user-defined places;
program code to determine a current probability of location event occurrence for the access terminal based at least in part on the behavior model; and
program code to select between a higher power-consumption positioning procedure and one or more lower power-consumption positioning procedures for determining the requested location based on the determined current probability of location event occurrence for the access terminal.

63. A non-transitory computer-readable medium containing instructions stored thereon, which, when executed by an access terminal, cause the access terminal to perform operations, the instructions comprising:
program code to receive a request for a location of the access terminal;
program code to determine a set of factors associated with a likelihood that a higher power-consumption positioning procedure for the access terminal is warranted, the set of factors including one or more of (i) a battery level of the access terminal, (ii) a behavior model indicative of a current probability of location event occurrence for the access terminal over a period of time, wherein a location event for the access terminal is characterized by the access terminal transitioning into and/or out of at least one of a set of user-defined places, (iii) motion or acceleration of the access terminal, (iv) presence or absence of WiFi signals, (v) ambient sound and/or (vi) availability of a terrestrial network positioning procedure; and
program code to evaluate the set of factors to determine whether to estimate the requested location via the higher power-consumption positioning procedure one or more lower power-consumption positioning procedures.
